(19) United States
(12) Patent Application Publication
(10) Pub. No.: US 2010/0153149 A1
(43) Pub. Date: Jun. 17, 2010

(54) SOFTWARE FOR MODEL-BASED CONFIGURATION CONSTRAINT GENERATION

(75) Inventors: Uta Prigge, Redwood City, CA (US); Florian Stallmann, Heidelberg (DE); Stefan Kaetker, Dossenheim (DE)

Correspondence Address: FISH & RICHARDSON, P.C., PO BOX 1022, MINNEAPOLIS, MN, 55440-1022, US

(73) Assignee: SAP AG

(21) Appl. No.: 12/333,874

(22) Filed: Dec. 12, 2008

(51) Int. Cl. G06Q 10/00

(52) U.S. Cl. 705/7

(57) ABSTRACT

This disclosure provides various embodiments of systems, software, and computerized methods for generating one or more business adaptation constraints. In one aspect, the software identifies at least one business option associated with a business adaptation catalog, and then identifies at least one variable application entity in an application mapped to the at least one identified business option. The software determines one or more application integrity constraints associated with the at least one identified variable application entity, and computes one or more business adaptation catalog constraints associated with the at least one identified business option based on the one or more determined application integrity constraints associated with the at least one identified variable application entity. The software then inserts the one or more computed business adaptation catalog constraints associated with the at least one identified business option into the business adaptation catalog.

### TECHNICAL FIELD

The present disclosure relates to methods and software for software modeling, and, more particularly, to methods and software for generating model-based configuration constraints.

### BACKGROUND

Enterprise software systems are generally large and complex. Such systems can require many different components, distributed across many different hardware platforms, possibly in several different geographical locations. In order to design, configure, update or implement an enterprise software system, one is generally required to understand details of the system at varying levels, depending on his role in designing, managing or implementing the system. For example, a systems administrator may need a high-level technical understanding of how various software modules are installed on physical hardware, such as a server device or a network, and how those software modules interact with other software modules in the system. A person responsible for configuring the software may utilize a high-level functional understanding of the operations that each functional component provides. An application designer may utilize a low-level technical understanding of the various software interfaces that portions of the application require or implement. Further, an application developer may utilize a detailed understanding of the interfaces and functionality he is implementing in relation to the remainder of the system. However, the flow of a business process within an application today is typically hidden from a user. In some cases, it is possible to manually create a textual or graphical documentation of this process flow. This documentation, however, is typically not detailed enough and can become quickly outdated since its consistency with the actual application software is not (initially) verified or maintained automatically.

Within a development environment, an application can be developed using modeling systems. In general, these models can specify the types of development objects or components that can be used to build applications, as well as the relationships that can be used to connect those components. In an object-oriented architecture, for example, a defined application can include a combination of various data objects and resources (i.e., development objects). In that example, relationships among the development objects can include a relationship indicating that one data object inherits characteristics from another data object. Another example architecture is the model-view-controller (MVC) architecture. Applications built using the MVC architecture typically include three different types of components—models, which store data such as application data; views, which display information from one or more models; and controllers, which can relate views to models, for example, by receiving events (e.g., events raised by user interaction with one or more views) and invoking corresponding changes in one or more models. When changes occur in a model, the model can update its views. Data binding can be used for data transport between a view and its associated model or controller. For example, a table view (or a table including cells that are organized in rows and columns) can be bound to a corresponding table in a model or controller. Such a binding indicates that the table is to serve as the data source for the table view and, consequently, that the table view is to display data from the table. Continuing with this example, the table view can be replaced by another view, such as a graph view. If the graph view is bound to the same table, the graph view can display the data from the table without requiring any changes to the model or controller. In the MVC architecture, development objects can include models, views, controllers, and components that make up the models, views, and controllers. For example, application data in a model can be an example of a component that is a development object.

To graphically model an application such that a combination of abstract, graphical representations represent the components of the application and the relationships between those components, a developer typically uses a drawing tool, such as Microsoft Visio, that provides abstract representations and tools for manipulating and/or generating abstract representations. For example, a user of the drawing tool (such as a developer) can choose to use a circle (or any other suitable abstract representation or model) to represent a class (such as a class defined in the C++ or other object-oriented programming language) of an application developed under the object-oriented architecture. The circle that represents a development object can include data from the development object. For example, a name of a class (i.e., data from a development object) can be entered in a text box that is part of the circle, and that name can be displayed in the center of the circle. In addition to drawing tools, the developer can also use other graphical tools to generate graphical representations and models (e.g., Unified Modeling Language (UML) diagrams or Business Process Execution Languages (BPEL)) from application code or vice versa.

### SUMMARY

This disclosure provides various embodiments of systems, software, and computerized methods for generating one or more business adaptation constraints. In one aspect, the software identifies at least one business option associated with a business adaptation catalog, and then identifies at least one variable application entity in an application mapped to the at least one identified business option. The software determines one or more application integrity constraints associated with the at least one identified variable application entity, and computes one or more business adaptation catalog constraints associated with the at least one identified business option based on the one or more determined application integrity constraints associated with the at least one identified variable application entity. The software then inserts the one or more computed business adaptation catalog constraints associated with the at least one identified business option into the business adaptation catalog.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1A illustrates an example system for modeling business adaptation catalogs (BACs) associated with one or more solutions in accordance with one embodiment of the present disclosure.

FIG. 1B illustrates an example association between a particular business adaptation catalog and its related application within the example modeling environment of FIG. 1A.

FIG. 2A depicts an example modeling environment in accordance with one embodiment of FIG. 1A.

FIG. 2B depicts a simplified process for mapping a model representation to a runtime representation using the example modeling environment of FIG. 2A or some other modeling environment.

FIG. 2C illustrates example modeling phases using the example modeling environment of FIG. 2A or some other modeling environment.

FIG. 3A is a flowchart illustrating an example method for generating a BAC model providing a visual representation of the information associated with a particular BAC.

FIG. 3B illustrates one generic example of a BAC as represented prior to the execution of the flowchart of FIG. 3A or methods similar thereto.

FIG. 3C illustrates one example set of modeling notations used in accordance with the flowchart of FIG. 3A or methods similar thereto.

FIG. 3D illustrates one generic example of a BAC model created in accordance with the flowchart of FIG. 3A or methods similar thereto.

FIGS. 4A and 4B illustrate two specific example BAC models created in accordance with the flowchart of FIG. 3A or methods similar thereto.

FIG. 5A is a flowchart illustrating an example method for generating a process component constraint model providing configuration controls and constraints between one or more application entities.

FIG. 5B illustrates one example of a process component model prior to the execution of the flowchart of FIG. 5A or methods similar thereto.

FIG. 5C illustrates one example of a process component constraint model created in accordance with the flowchart of FIG. 5A or methods similar thereto.

FIG. 5D illustrates one example of a process component constraint model including external constraints in accordance with the flowchart of FIG. 5A or methods similar thereto.

FIG. 6A is a flowchart illustrating an example method for generating a business adaptation to architecture mapping model providing a mapping representing the relationship between one or more variable entities of an application and one or more business options of an associated BAC.

FIGS. 6B-6D illustrate examples of generic business adaptation to architecture mapping models created in accordance with the flowchart of FIG. 6A or methods similar thereto.

FIG. 6E illustrates one concrete example of a business adaptation to architecture mapping model created in accordance with the flowchart of FIG. 6A or methods similar thereto.

FIG. 7A is a flowchart illustrating an example method for verifying and generating one or more constraints within a BAC based on one or more constraints defined in a related application.

FIGS. 7B-7I illustrate a generic example of the BAC constraints generated in accordance with the flowchart of FIG. 7A or methods similar thereto.

### DETAILED DESCRIPTION

This disclosure generally describes an example environment 100 for creating and modeling additional variability for functions and data in an application, modeling information associated with one or more solutions used in connection with the application, and modifying and verifying the business integrity of both the application and its related solutions. At a high level, the model is a representation of a software system, part of a software system, or an aspect of a software system. The model can be associated with one or more views. A view of the model represents a subset of the information in the model. For purposes of discussion, the term “model” will be used to refer to both the model and a view of the model. The model, such as illustrated model 104, can be used in a software development process to describe or specify a software application, or parts or aspects of a software application, for developers implementing or modifying the application. The model specifies the design to a useful level of detail or granularity. In this way, a compliant implementation or deployment of the modeled functionality can conform to the specification represented by the model. For example, the model may represent a sequence of steps, executed to achieve a business result. According to the particular design, each step can result in the change of state of a business object. Business processes can be part of, triggered by, and superior to other business processes. Business processes can be modeled in a hierarchy. As described herein, the business process hierarchy includes a requirements definition, design specification, and implementation description level, but other ways of defining a business process or other view hierarchy are possible. Thus, the models described herein can be written in description notations appropriate for process modeling. As described in more detail below, the model may include any number of logical layers, each of which include one or more domains and represent a logical category of modeling such as high level business views, system independent process views, and implementation views. Each layer may be considered a sub-model or a model in its own right that can be bound with other layers/models. Moreover, each logical layer can—in some cases—be bound with a plurality of lower layers, such as one system independent process view being bound to a number of disparate, but similar, implementation views. Often, the domains in one layer substantially match the domains in other bound layers.

In this disclosure, techniques are provided to create and define one or more configuration controls in an application to provide additional points of built-in variability to functions and data within the application. Additional techniques are described for defining and modeling a set of constraints between these newly created configuration controls and other existing application engineering entities. One advantage of the configuration controls and their associated constraints is that they allow an application's business integrity to be ensured. In other words, the constraints are used to define certain requirements and relationships between application (or engineering) entities that must be met in order for the application (or instances of the application platform) to execute properly. In some instances, configuration controls and other engineering entities representing the variability of the application (collectively described as “variable engineering entities”) can be mapped to or associated with certain business elements of a business adaptation catalog associated with the solution that is built upon or in association with the underlying application. By mapping the business elements of the solution's business adaptation catalog to the variable and other engineering entities of the associated application, the configuration of the business adaptation catalog can be verified against the application's defined constraints to ensure that the each solution adheres to the business and logical integrity of the application and the requirements specified by the associated BAC. By verifying the relationship between these engineering and business entities via mapping and a model visualizing that mapping, runtime errors and issues caused by incompatibilities between the solution's BAC and its underlying application can be prevented before executing the solution. Further, this disclosure provides techniques for mapping configuration controls and other variable engineering entities of the application to one or more business elements associated with consumption (or business) entities associated with the BAC (or BACs) built on top of the application. The mapping between the business elements (of the BAC) and application's engineering entities can be visualized via one or more generated models to provide transparency and clear understanding to both customers and developers, providing detailed working models based upon the relationship between the underlying application and the one or more associated BACs. Still further, this disclosure provides additional techniques for generating (in some cases, automatically) constraints between the consumption (or business) elements of the BAC and the variable (and other) engineering entities of the solution's underlying application, the constraints based upon the required constraints and defined integrity relationships defined for the underlying application. Additionally, the techniques for generating the constraints can also be used to verify constraints previously defined for the BAC. By automatically generating the constraints associated with the BAC, consistency between the solution's application and BAC can be maintained so that inconsistent applications and solutions are minimized and/or avoided. Further, the automatic generation of constraints allows customers and developers of the solutions to avoid being concerned with the development of integrity constraints, and instead allows them to focus on generating the proper combination of the application's engineering entities and the BAC's consumption entities for the current situation.

In the context of this disclosure, the term “solution” represents a specific product or software provided to one or more users. Each solution comprises an application, which in turn comprises a set of development entities (interfaces, services, coding, data types, tables, etc.) that are used and/or executed by an end user or customer (in connection with the solution). The application provides a certain set of services, offers a certain set of functionality, and supports a certain set of processes. In general, each application may, either in part or in whole, consist of or reuse the development and engineering entities of an application platform. The application platform is also a set of development entities like the application, but oriented towards reuse and thus variability, but without the solution-specific portions (i.e., the BAC or the user interface (UI) associated with the application and solution). The applications associated with different solutions may include or be based upon varying portions of the application platform according to the needs of the application's associated solution. While the underlying application platform provides the general description of a broad software architecture, each application may be associated with at least a portion of that architecture according to the needs of the solution and the end user for whom the solution is being developed. In addition to the application, each solution can also include one or more BACs, wherein the BACs expose the capabilities or functionality of the solution's application to an end (or business) user at a different level of abstraction from the application, and using terminology that is adapted to the specific target audience of the solution. By adapting the terminology to the specific target audience, the end (and business) users can select various elements from the BAC to provide a consistent subset of the available services, functionality, and processes associated with the related application that are exposed by the BAC of the solution. The solution, including the portions of the application and BAC selected in the consistent subset, can then be deployed to an end (or business) user's system, resulting in a user-specific customization of the application and solution.

Thus, in this disclosure, techniques are provided to model the development (or engineering) entities of an application with (in particular) their associated consistency constraints, the totality of which make up the engineering view or level of the solution. Additionally, techniques are provided to model the BAC associated with a particular solution, with its business elements and their associated selection or consumption constraints. The BAC makes up a consumption view or level of the solution. Further, techniques are provided to model the relationship between the elements of the application's engineering level view and the BAC's consumption level view. Additionally, techniques are provided to verify the validity, consistency, and sufficiency of the selection constraints associated with the BAC at the consumption level with regards to the consistency constraints associated with the application at the engineering level.

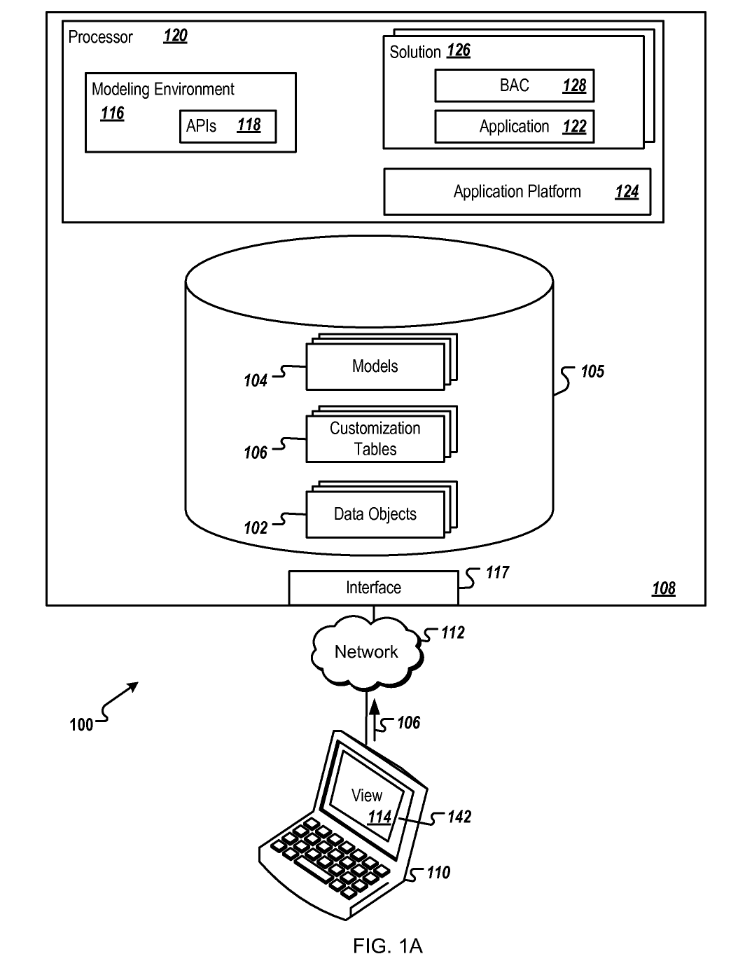

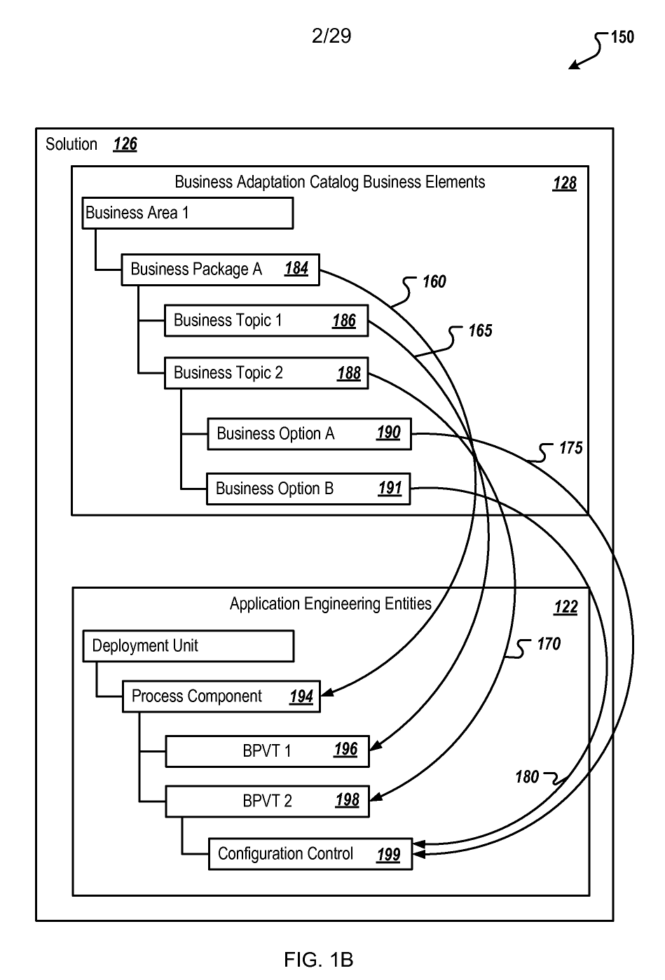

With respect to example FIG. 1A, environment 100 is typically a distributed client/server system that spans one or more networks such as 112. As described above, rather than being delivered as packaged software, portions of environment 100 may represent a hosted solution, often for an enterprise or other small business, that may scale cost-effectively and help drive faster adoption. In this case, portions of the hosted solution may be developed by a first entity, while other components are developed by a second entity. Moreover, the processes or activities of the hosted solution may be distributed amongst these entities and their respective components. In some embodiments, environment 100 may be in a dedicated enterprise environment—across a local area network or subnet—or any other suitable environment without departing from the scope of this disclosure.

Turning to the illustrated embodiment, environment 100 includes or is communicably coupled with server 108 and one or more clients 110, at least some of which communicate across network 112. Server 108 comprises an electronic computing device operable to receive, transmit, process and store data associated with environment 100. For example, server 108 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). But, more generally, FIG. 1A provides merely one example of computers that may be used with the disclosure. Each computer is generally intended to encompass any suitable processing device. For example, although FIG. 1A illustrates one server 108 that may be used with the disclosure, environment 100 can be implemented using computers other than servers, as well as a server pool. Indeed, server 108 may be any computer or processing device such as, for example, a blade server, general-purpose personal computer (PC), Macintosh, workstation, Unix-based computer, or any other suitable device. In other words, the present disclosure contemplates computers other than general purpose computers, as well as computers without conventional operating systems. Server 108 may be adapted to execute any operating system including Linux, UNIX, Windows Server, or any other suitable operating system. According to one embodiment, server 108 may also include or be communicably coupled with a web server and/or a mail server.

Illustrated server 108 includes example processor 120. Although FIG. 1A illustrates a single processor 120 in server 108, two or more processors may be used according to particular needs, desires, or particular embodiments of environment 100. Each processor 120 may be a central processing unit (CPU), a blade, an application specific integrated circuit (ASIC), or a field-programmable gate array (FPGA). The processor 120 may execute instructions and manipulate data to perform the operations of server 108, often using software. Regardless of the particular implementation, “software” may include computer-readable instructions, firmware, wired or programmed hardware, or any combination thereof on tangible medium as appropriate. Indeed, each software component may be fully or partially written or described in any appropriate computer language including C, C++, Java, Visual Basic, assembler, Perl, any suitable version of 4GL, as well as others. It will be understood that while the software illustrated in FIG. 1A is shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

In the illustrated embodiment, processor 120 executes model-driven development tool (or environment) 116, modeled business application platform 124, and one or more solutions 126 based on the modeled business application platform 124. At a high level, the modeling environment 116, application platform 124, and solutions 126 are operable to receive and/or process requests from developers and/or users and present at least a subset of the results to the particular user via an interface.

The GUI modeling environment 116 may be or implement any development tool, toolkit, application programming interface (API), application, or other framework that allows a developer to develop, configure, and utilize various business elements that can be more easily modeled during modeling (or during design time) of a particular business application. For example, the model-driven framework or environment may allow the developer to use simple drag-and-drop techniques to develop pattern-based or freestyle user interfaces and define the flow of data between them. Such drag and drop techniques may include selecting, inputting, identifying, or some other indication that the developer is interested in a particular object or element. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding; in other words, the modeling environment can be used to create, modify, and examine the model.

Further, the modeling environment 116 may include or be coupled with a modeling API 118. The modeling API 118 may be any API exposing the functionality of the modeling environment 116, as well as the information and data associated with or defined in the modeling environment. The modeling API 118 can be used by one or more external applications or entities to access and read information associated with one or more models 104 defined by or in the modeling environment 116. Information defining or associated with the relationships between two or more models 104, various entities in a single model 104, or associated or linked entities located in multiple models 104, can be retrieved and incorporated with newly created and/or previously-defined models.

In some cases, this example modeling environment 116 may provide a personalized, secure interface that helps unify enterprise applications, information, and processes into a coherent, role-based portal experience. Further, the modeling environment may allow the developer to access and share information and applications in a collaborative environment. In this way, virtual collaboration rooms allow developers to work together efficiently, regardless of where they are located, and may enable powerful and immediate communication that crosses organizational boundaries, while enforcing security requirements. Indeed, the modeling environment 116 may provide a shared set of services for finding, organizing, and accessing unstructured content stored in third-party repositories, and content management systems across various networks 112. Classification tools may automate the organization of information, while subject-matter experts and content managers can publish information to distinct user audiences. Regardless of the particular implementation or architecture, this modeling environment 116 may allow the developer to easily model various elements using this model-driven approach. As described in more detail later, the model is deployed, and environment 100 may translate the model into the required code or data structures for at least one application platform 124 or web service. When deployed, the application platform 124 may then be modified or enhanced, as appropriate, into a specific version of the application platform 124 (described as the application 122 in FIG. 1A) using the modeling environment 116. In general, the application platform 124 represents a set of development and engineering entities (i.e., interfaces, services, engineering entities, coding, data types, tables, etc.) that are oriented toward reuse and thus variability. One or more applications 122 may be based upon a portion or all of the application platform 124 to perform one or more operations or roles within the solution 126.

More specifically, the application platform 124 may represent any modeled software or other portion of business functionality or logic. A first instance of application platform 124 may represent a first application that is .NET-based, while a second instance of application platform 124 may be a similar hosted web-based solution. In yet another example, application platform 124 may be a modeled composite application with any number of portions that may be implemented as Enterprise Java Beans (EJBs), or the design-time components may have the ability to generate run-time embodiments into different platforms such as J2EE, ABAP (Advanced Business Application Programming) objects, or Microsoft's .NET. In a further example, application platform 124 may merely be a modeled and published web service. Further, while illustrated as internal to server 108, one or more processes associated with modeling environment 116 or application platform 124 may be stored, referenced, or executed remotely. For example, a portion of an application may be a web service that is remotely called, while another portion of the application may be an interface object bundled for processing at remote client 110. Moreover, modeling environment 116 or application platform 124 may each be a child or sub-module of other respective software modules or enterprise applications (not illustrated) without departing from the scope of this disclosure.

In particular, the application platform 124 can be implemented to realize a software application that implements enterprise application service interfaces using a number of elements associated with and defining its architectural design. The elements of the application platform's 124 architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

Generally, the architectural elements, or engineering entities, of the application platform 124 include the business object. A business object is a representation of a type of a uniquely identifiable business entity (an object instance) described by a structural model. Processes operate on business objects. A business object represents a specific view on some well-defined business content. A business object represents content, and instances of business objects include content, which a typical business user would expect and understand with little explanation. Whether an object as a type or an instance of an object is intended by the term “object” is generally clear from the context, so the distinction will be made explicitly only when necessary. Also, for convenience and brevity, an object instance may be described in this specification as being or including a real world event, activity, item, or the like; however, such description should be understood as stating that the object instance represents (i.e., contains data representing) the respective event, activity, item, or the like. Properly implemented, business objects are implemented free of redundancies.

Business objects can be further categorized as business process objects, master data objects, mass data run objects, dependent objects, and transformed objects. A master data object is an object that encapsulates master data (i.e., data that is valid for a period of time). A business process object, which is the kind of business object generally found in a process component, is an object that encapsulates transactional data (i.e., data representing a business entity or functionality that is valid for a point in time) and exposes services or interfaces that transform that data. A mass data run object is an application object that executes an algorithm for a particular mass data run. An instance of a mass data run object embodies or contains a particular set of selections and parameters. A mass data run object implements an algorithm that modifies, manages, and/or processes a large amount of data in multiple transactions, possibly but not necessarily with parallel processing. A dependent object is a business object used as a reuse part in another business object. A dependent object represents a concept that cannot stand by itself from a business point of view. Instances of dependent objects only occur in the context of a non-dependent business object. A transformed object is a transformation of multiple business objects for a well-defined purpose. It transforms the structure of multiple business objects into a common structure. A transformed object does not typically have its own persistency.

The architectural elements, or engineering entities, of the application platform 124 also include the process component. A process component is a software package that realizes a business process and generally exposes its functionality as services. Examples for process components are: due item processing, sales order processing, purchase order processing. The functionality includes the ability to perform all or parts of particular kinds of business transactions. It acts as a reuse element in different integration scenarios and is a modeling entity. A process component contains one or more semantically related business objects. Any business object belongs to no more than one process component.

Process Components are mainly modeling entities to group BOs, bundle web service calls to message choreographies and collect configuration settings. For configuration, Process Components are used to assign Business Process Variant Types to business configuration and for addressing of messages. As such, process components are modular and context-independent. That they are context-independent means that a process component is not specific to any specific application and is reusable.

The architectural elements (or engineering entities) also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters, or some combination of them, serving as a signature. The system can optionally include a repository of service descriptions that includes a standards-based description of each of the supported service operations.

The architectural elements (or engineering entities) also include the service interface, which may be referred to simply as an interface. An interface is a named group of operations. Each operation belongs to exactly one interface. An interface belongs to exactly one process component. A process component might implement multiple interfaces. In some implementations, an interface will have only inbound or outbound operations, but not a mixture of both. One interface can include both synchronous and asynchronous operations. All operations of the same type (either inbound or outbound) which belong to the same message choreography will preferably belong to the same interface. Thus, generally, all outbound operations to the same other process component are in one interface.

The architectural elements (or engineering entities) also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation of the other process component sending a message to the first process component.

The architectural elements (or engineering entities) also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a business object instance is created, updated, or deleted.

Synchronous outbound process agents are generally triggered directly by a business object.

An outbound process agent will generally perform some processing of the data of the business object instance whose change triggered the agent or caused the agent to be called. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements (or engineering entities) also include the deployment unit. A deployment unit includes one or more process components and, optionally, one or more business objects, that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interactions (i.e., interactions between process components involving their respective business objects, operations, interfaces, and messages) within other deployment units. Similarly, process components that interact with other process components or external systems only through messages, e.g., as sent and received by operations, can also be replaced as long as the replacement supports the operations of the original.

Interactions between process components that occur only within a deployment unit are not constrained to using service operations. These can be implemented in any convenient fashion.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are preferably assigned to their respective deployment unit.

In some variations, process components are associated with one or more Business Process Variant Types (“BPVTs”). A BPVT is a modeling entity that represents a typical way of processing within a process component from a business point of view. A BPVT defines which process agents of a particular process component are activated, which in turn defines other external process components with which the particular process component interacts. The criteria to define a BPVT can include associated message choreographies or business configuration parameters belonging to different BPVTs of a particular process component. In some cases, BPVTs of one process component can have the same message choreography as another process component while the business configuration settings differ. As a result, the message choreography of a particular process component differs for each different BPVTs of that particular process component. In certain configurations, there are two categories of BPVTs: main BPVTs that are unique for a particular business object or business object node and additional BPVTs that are optional and exist in combination with a main BPVT.

During application run-time, the BPVT will be derived (based on business configuration settings, master data, incoming messages or user interaction) and stored in a business object node. The derived BPVT could be passed in a message or used as one of the parameters in a relevance condition of the outbound process agent. BPVTs can be passed in connection with service and support error tickets (to allow, for example, an embedded support scenario).

BPVTs can be used to ensure consistency among different deployments. Moreover, BPVTs can be used to verify that process interaction models associated with a particular integration scenario have been correctly assigned. Generally, however, BPVTs allow developers and application designers to create varying process flows within defined process components, allowing a particular process component to perform different tasks or operations based upon the business scenario or situation related to a particular instance of the process component.

As illustrated in FIG. 1A, processor 120 may also execute or request execution of one or more solutions 126. Each solution 126 includes a customized version of the application platform 124 (herein referred to as the application 122) specific to the requirements and desires of the customer, as well as a business adaptation catalog (BAC) 128. In some instances, each solution 126 may represent a specific implementation or configuration of the application platform 124, such that distribution of the a particular solution 126 may allow the configuration data defined for the particular BAC 128 to be used in connection with the engineering entities of application 122. In some instances, the application 122 associated with a particular solution 126 may be defined by the engineering entities of the application platform 124 required or associated with the high-level business needs of an end user or customer, and may remove at least a portion of the technical interactions and engineering elements of the application platform 124 from the solution 126 and therefore the customer's concern, allowing the customer to focus on more tailored business-based solutions and roles.

Each solution 126 may also include a BAC 128, which includes a set of business elements associated with the engineering entities of the application 122, but at a different level of abstraction. Each business element may be a business area, a business package, a business topic, or a business option. The business area may represent a logical grouping of related application modules or sub-modules, models, operations, or other relevant entities that are related to a particular business function or other functionality as defined in the modeled application platform 124 (or application 122). In some instances, the one or more business areas associated with a particular solution 126 may represent only a portion of the business areas and functionality provided by or available in the underlying application 122. Because only portions of the application 122 that are relevant to the customer are configured as part of or associated with the solution 126, the customer can focus on using and mastering only the functionality and portions of the application platform 124 (and therefore, the application 122) relevant to the customer's needs, thereby avoiding interactions with and requiring further understanding of the additional functionality typically available throughout the entire application 122. Additionally, by tailoring the BAC 128 and application 122 to the business areas and functionality relevant to the customer, more cost-effective and manageable solutions may be provided to customers on an individualized basis, thereby potentially reducing the total cost of ownership.

Each business area (e.g., Sales and Distribution) of the solution's BAC 128 may include or be associated with a number of business packages. Each business package may represent an activity or other functionality associated with the business area. For instance, in the example where the business area represents Sales and Distribution for a customer, an example business package within the Sales and Distribution business area would be Selling Products and Services. Further, each business package may include a set of business topics related to the business package. Continuing with the present example, the Selling Products and Services business package may include several business topics, including Sales Orders and Service Orders. In other words, the business topics may represent various functionality related to the business package. Finally, each business topic may be associated with one or more business options, providing customers with the ability to configure the various functionality, activities, and entities associated with each business topic. For instance, the Sales Order business topic may include a business option determining the number range associated with each Sales Order produced by the customer's business. Each business option may be associated with a business configuration set defining the values for that particular business option.

In one implementation, such as that of illustrated FIG. 1A, each solution 126 may be associated with a single BAC 128. In some instances, the information defining the particular BAC 128 may be represented hierarchically, e.g., in a data tree structure or other text-based storage. While illustrated as part of the solution 126, the BAC 128 may be stored in memory 105 in certain implementations and accessed via the internal connections of server 108. In other instances, the BAC 128 may be stored external to server 108 and accessible by the processor 120 via the network 112. In other instances, one BAC 128 may be shared among the plurality of solutions 126, wherein certain business elements from the BAC 128 (and their associated engineering entities of the application 122) are selected for each solution 126 according to the needs of similar customers. In those instances, each solution 126 (and the application 122) may reference the relevant portions of the shared BAC 128 during runtime to retrieve the data necessary for the solution 126 to operate properly.

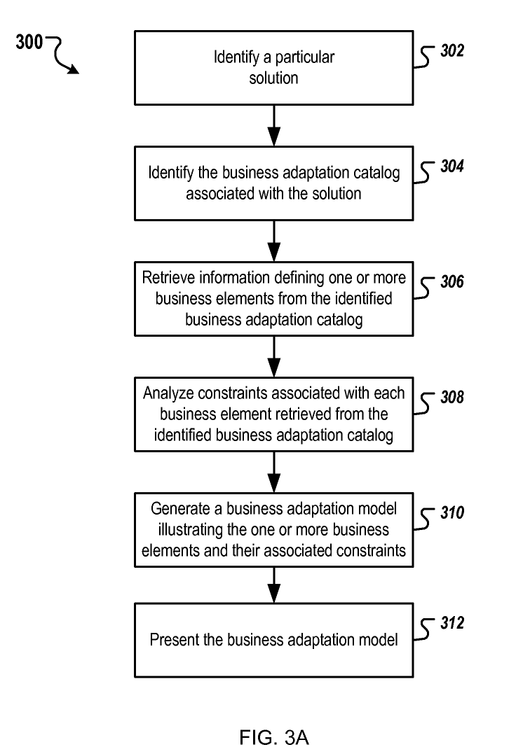

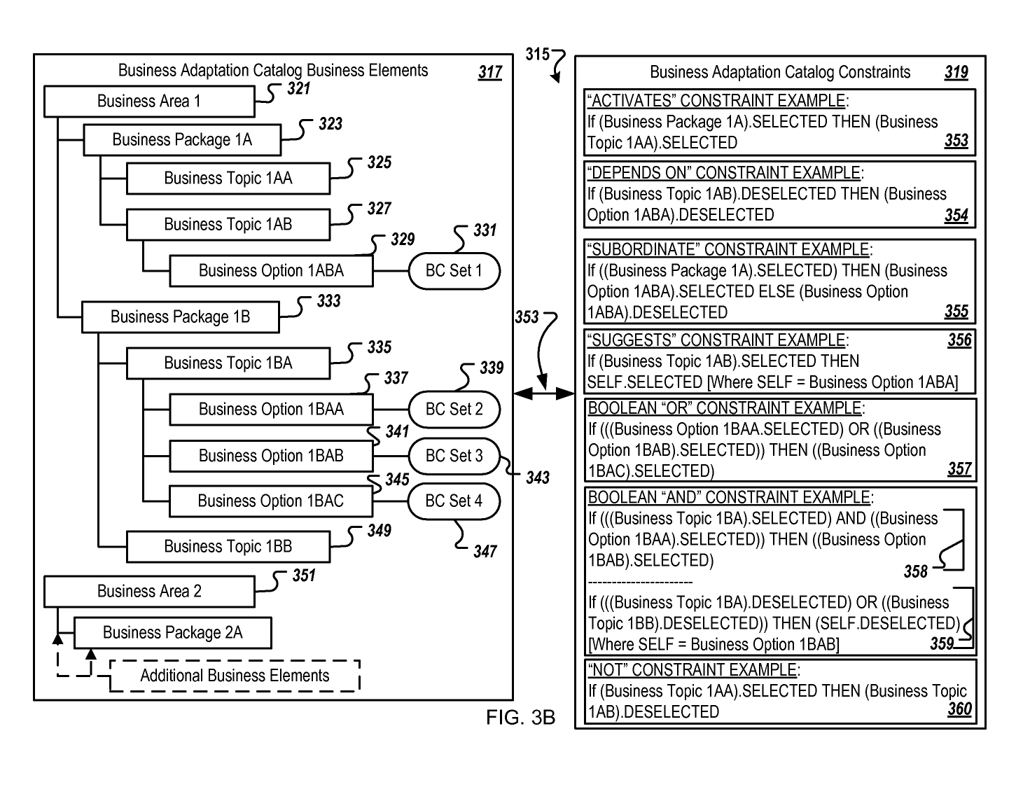

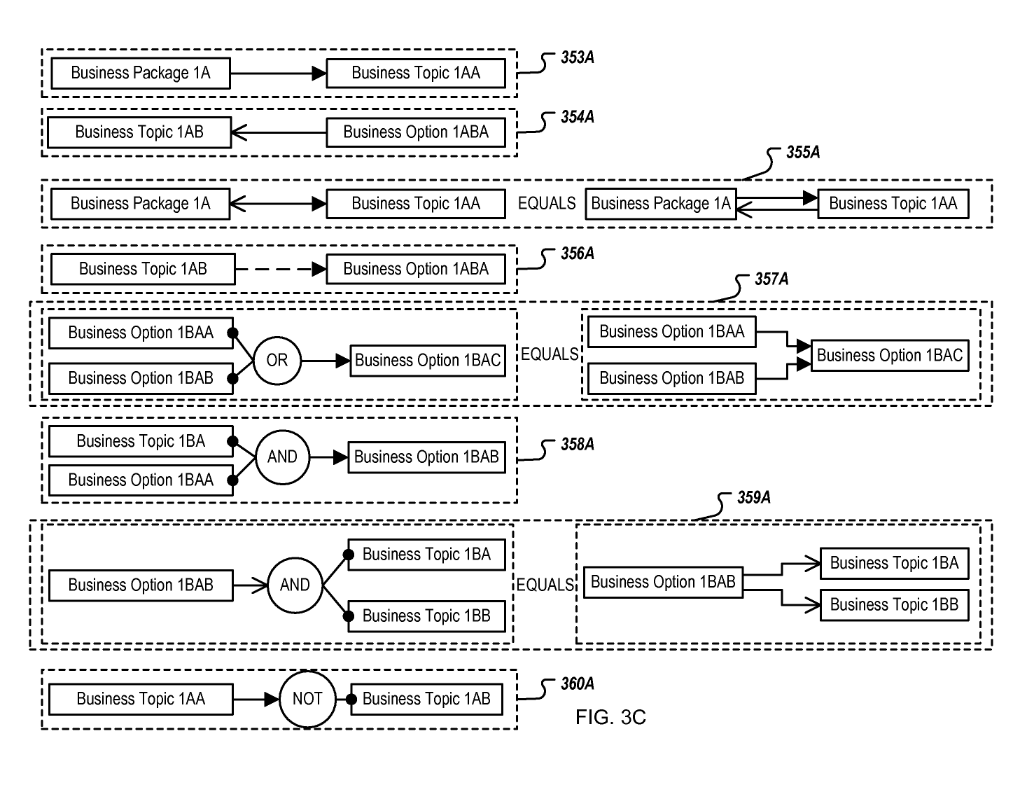

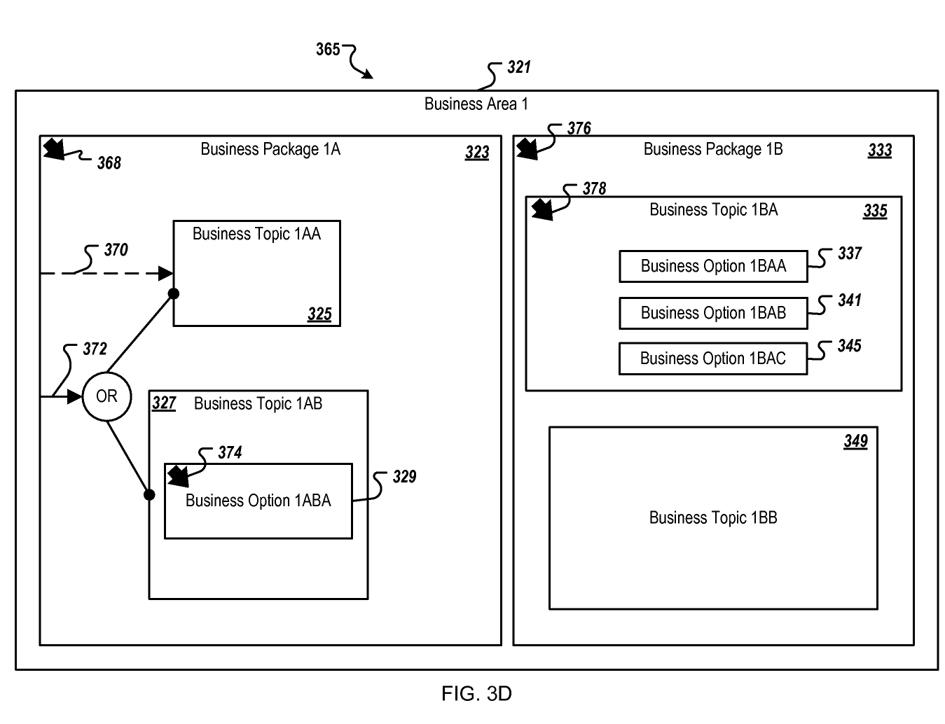

Each solution 126 may be defined by a developer working or associated with the customer in order to provide a solution specific to the customer's needs. This creation process may include the customer analyzing the BAC 128 to determine which business elements (i.e., business areas, business packages, business topics, and business options) will be part of the particular solution 126. In some instances, various constraints may be associated with each BAC 128 associated with the particular solution 126. The constraints of the BAC 128 are used to maintain the integrity of each solution 126 associated with the BAC 128 by ensuring that each business element selected for the particular solution 126 has its related and required associated business elements also selected that are required by the engineering level of the associated application 122. An example BAC 128 is illustrated in FIG. 3B, and will be described in detail later. An example of the relationship between a BAC 128 and the related application 122 is illustrated by the generic model 150 in FIG. 1B. As previously described, the application 122 and the BAC 128 associated with a particular solution 126 represent the functionality of the solution 126 at two different levels of abstraction, the engineering level provided by the application 122 and the consumption level provided by the BAC 128. As illustrated by the connections of model 150, each business element (or consumption entity) within the BAC 128 is connected to a particular engineering or application entity in the application 122. For example, Business Package A 184 is associated with the process component 194 (represented by line 160), Business Topic 1 186 is associated with BPVT 1 196 (represented by line 165), Business Topic 2 188 is associated with BPVT 2 198 (represented by line 170), and Business Options A 190 and B 191 are both associated with the Configuration Control 199 (represented by lines 175 and 180, respectively). These relationships indicate that when the illustrated elements of the BAC 128 are activated in the solution, the engineering entities of the application 122 associated with the activated BAC elements will also be activated. The BAC 128, therefore, acts as a type of configurator mechanism for the solution 126, wherein selecting various elements within the BAC 128 configures or activates certain entities associated with the application 122. Depending on the BAC's 128 selection, various portions of the application's 122 functionality and operations will be exposed, and available for use upon deployment or execution of the solution 126.

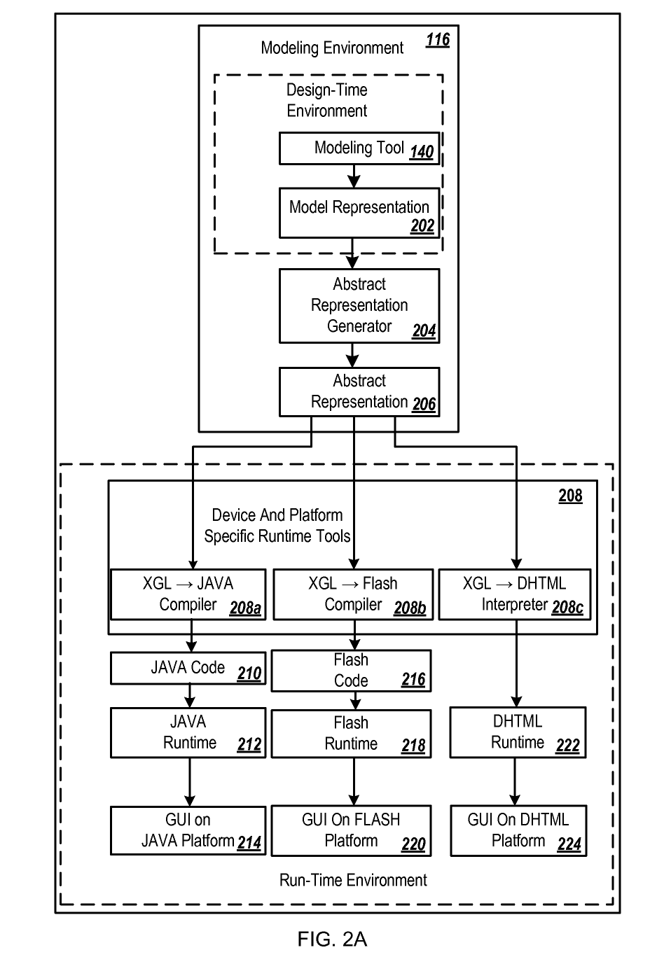

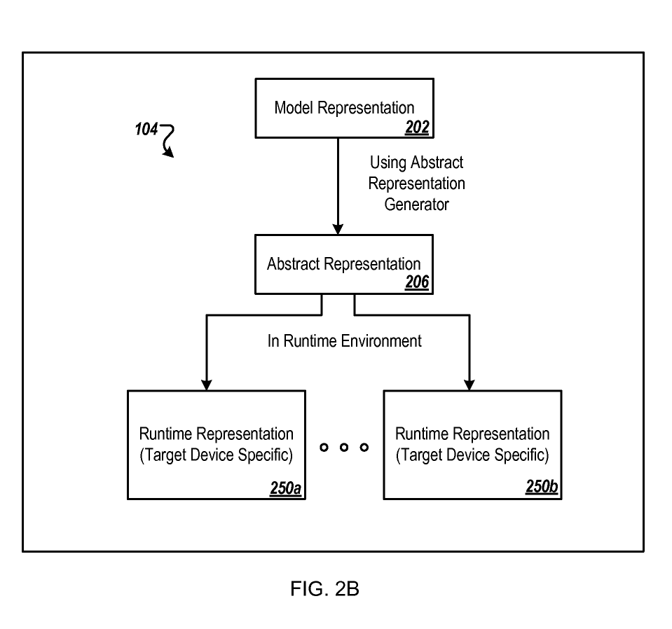

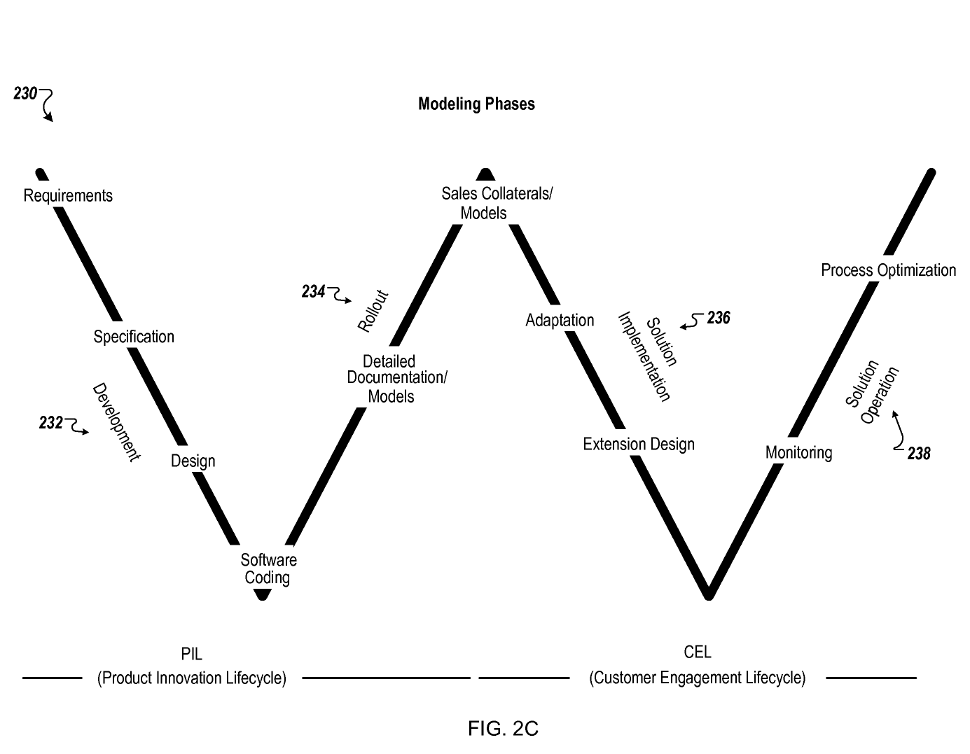

FIG. 2A depicts a more detailed example modeling environment 116, in accordance with one embodiment of the present disclosure. Such a modeling environment 116 may implement techniques for decoupling models created during design-time from the runtime environment. In other words, model representations for GUIs created in a design-time environment are decoupled from the runtime environment in which the GUIs are executed. Often, in these environments, a declarative and executable representation for GUIs for applications is provided that is independent of any particular runtime platform, GUI framework, device, or programming language.

In certain embodiments, the modeling environment 116 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and, therefore, can unambiguously encapsulate execution semantics for the GUI described by a model representation. In short, models of different types can be transformed to XGL representations.

The XGL representation may be used for generating representations of various different GUIs and supporting various GUI features, including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 2A, modeling tool 140 may be used by a GUI designer or business analyst during the application design phase to create a model representation 202 for a GUI application. It will be understood that modeling environment 116 may include or be compatible with various different modeling tools 140 used to generate model representation 202. This model representation 202 may be a machine-readable representation of an application or a domain specific model. Model representation 202 generally encapsulates various design parameters related to the GUI such as GUI components, dependencies between the GUI components, inputs and outputs, and the like. Put another way, model representation 202 provides a form in which the one or more models can be persisted and transported, and possibly handled by various tools such as code generators, runtime interpreters, analysis and validation tools, merge tools, and the like. In one embodiment, model representation 202 maybe a collection of XML documents with a well-formed syntax.

Illustrated modeling environment 116 also includes an abstract representation generator (or XGL generator) 204 operable to generate an abstract representation (for example, XGL representation or XGL-compliant representation) 206 based upon model representation 202. Abstract representation generator 204 takes model representation 202 as input and outputs abstract representation 206 for the model representation. Model representation 202 may include multiple instances of various forms or types, depending on the tool/language used for the modeling. In certain cases, these various different model representations may each be mapped to one or more abstract representations 206. Different types of model representations may be transformed or mapped to XGL representations. For each type of model representation, mapping rules may be provided for mapping the model representation to the XGL representation 206. Different mapping rules may be provided for mapping a model representation to an XGL representation 206.

This XGL representation 206 that is created from a model representation may then be used for processing in the runtime environment. For example, the XGL representation 206 may be used to generate a machine-executable runtime GUI (or some other runtime representation) that may be executed by a target device. As part of the runtime processing, the XGL representation 206 may be transformed into one or more runtime representations, which may indicate source code in a particular programming language, machine-executable code for a specific runtime environment, executable GUI, and so forth, that may be generated for specific runtime environments and devices. Since the XGL representation 206, rather than the design-time model representation, is used by the runtime environment, the design-time model representation is decoupled from the runtime environment. The XGL representation 206 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 206 generated for a model representation 202 is generally declarative and executable in that it provides a representation of the GUI of model 202 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 206 is also not GUI runtime platform-specific. The abstract representation 206 provides a self-contained, closed, and deterministic definition of all aspects of a graphical user interface that is device independent and language independent.

Abstract representation 206 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), and the GUIs generated by the devices are consistent with each other in their appearance and behavior.

Abstract generator 204 may be configured to generate abstract representation 206 for models of different types, which may be created using different modeling tools 140. It will be understood that modeling environment 116 may include some, none, or other sub-modules or components as those shown in this example illustration. In other words, modeling environment 116 encompasses the design-time environment (with or without the abstract generator or the various representations), a modeling toolkit (such as 140) linked with a developer's space, or any other appropriate software operable to decouple models created during design-time from the runtime environment. Abstract representation 206 provides an interface between the design-time environment and the runtime environment. As shown, this abstract representation 206 may then be used by runtime processing.

As part of runtime processing, modeling environment 116 may include various runtime tools 208 and may generate different types of runtime representations based upon the abstract representation 206. Examples of runtime representations include device or language-dependent (or specific) source code, runtime platform-specific machine-readable code, GUIs for a particular target device, and the like. The runtime tools 208 may include compilers, interpreters, source code generators, and other such tools that are configured to generate runtime platform-specific or target device-specific runtime representations of abstract representation 206. The runtime tool 208 may generate the runtime representation from abstract representation 206 using specific rules that map abstract representation 206 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 206 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 2A, an XGL-to-Java compiler 208a may take abstract representation 206 as input and generate Java code 210 for execution by a target device comprising a Java runtime 212. Java runtime 212 may execute Java code 210 to generate or display a GUI 214 on a Java-platform target device. As another example, an XGL-to-Flash compiler 208b may take abstract representation 206 as input and generate Flash code 216 for execution by a target device comprising a Flash runtime 218. Flash runtime 218 may execute Flash code 216 to generate or display a GUI 220 on a target device comprising a Flash platform. As another example, an XGL-to-DHTML (dynamic HTML) interpreter 208c may take abstract representation 206 as input and generate DHTML statements (instructions) on the fly which are then interpreted by a DHTML runtime 222 to generate or display a GUI 224 on a target device comprising DHTML platform.

It should be apparent that abstract representation 206 may be used to generate GUIs for Extensible Application Markup Language (XAML) or various other runtime platforms and devices. The same model representation 206 may be mapped to various runtime representations and device-specific and runtime platform-specific GUIs. In general, in the runtime environment, machine executable instructions specific to a runtime environment may be generated based upon the abstract representation 206 and executed to generate a GUI in the runtime environment. The same XGL representation may be used to generate machine executable instructions specific to different runtime environments and target devices.

According to certain embodiments, the process of mapping a model representation 202 to an abstract representation 206 and mapping an abstract representation 206 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 206 rather than model representation 202 for runtime processing, the model representation 202 that is created during design-time is decoupled from the runtime environment. Abstract representation 206 thus provides an interface between the modeling environment and the runtime environment. As a result, changes may be made to the design time environment, including changes to model representation 202 or changes that affect model representation 202, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies, such as the target device platform or programming language dependencies.

FIG. 2B depicts an example process for mapping a model representation 202 to a runtime representation using the example modeling environment 116 of FIG. 2A or some other modeling environment. Model representation 202 may comprise one or more model components 104 and associated properties that describe a modeling domain, such as interfaces, processes, and data. The abstract representation 206 is generated based upon model representation 202. Abstract representation 206 may be generated by the abstract representation generator 204. Abstract representation 206 comprises one or more abstract GUI components and properties associated with the abstract GUI components. As part of generation of abstract representation 206, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 250a and 250b, including GUIs for specific runtime environment platforms, may be generated from abstract representation 206. A device-dependent runtime representation may be generated for a particular type of target device platform to be used for executing and displaying the GUI encapsulated by the abstract representation. The GUIs generated from abstract representation 206 may comprise various types of GUI elements such as buttons, windows, scrollbars, input boxes, etc. Rules may be provided for mapping an abstract representation to a particular runtime representation. Various mapping rules may be provided for different runtime environment platforms.

As described with respect to FIG. 2A, modeling tool 140 may be used by a GUI designer or business analyst during the application design phase to create a model representation 202 for a GUI application. In addition, modeling tool 140 may be used during other modeling phases and by other types of users to create model representations 202 for a GUI application. FIG. 2C illustrates example modeling phases 230 using the example modeling environment 116 of FIG. 2A or some other modeling environment. Modeling phases 230 may include development 232, rollout 234, solution implementation 236, and solution operation 238. In some implementations, development 232 and rollout 234 represent a product innovation lifecycle, while solution implementation 236 and solution operation 238 represent a customer engagement lifecycle. Development 232 may include, for example, determining requirements of a product or application, writing a specification for the product or application, designing the product or application, and writing software code for the product or application. Rollout 234 may continue with software coding, and also includes generating detailed documentation and/or detailed models, as well as sales collaterals and/or sales models. Solution implementation 236 may continue with generation of sales collaterals and/or models, and also includes adapting the product or application, as well as extending the design of the product or application. Solution operation 238 may include, for example, monitoring the product or application and optimizing processes in the product or application.

Returning to FIG. 1A, server 108 often includes local memory 105. Memory 105 may include any memory or database module and may take the form of volatile or non-volatile (tangible) memory including, without limitation, magnetic media, optical media, random access memory (RAM), read-only memory (ROM), removable media, or any other suitable local or remote memory component. Illustrated memory 105 includes one or more data objects 102, a process content directory 106, and, at some point, one or more modeled elements 104. Memory 105, however, may also include any other appropriate data such as HTML files or templates, data classes or object interfaces, software applications or sub-systems, additional repositories for storing backend information associated with and/or defining the one or more modeled elements 104, and others (whether illustrated or not). For example, memory 105 may include pointers or other references to data objects 102 that were published to a location remote from server 108. In this way, a local developer or non-technical business analyst may use a remote model 104 or modeling domain to efficiently supplement the particular aspect that he is modeling or viewing.

Data objects 102 are elements for information storage in object-oriented computing systems. Data objects can describe the characteristics of an item using a series of data fields that, for example, can correspond to described characteristics. Typically, a programmer will predefine standard object classes, referred to in the present specification as object types, that are hardcoded into a set of machine-readable instructions for performing operations. Object types are blueprints for describing individual objects using a defined set of class attributes (or properties). Instantiated objects that are members of such standard object types can be applied in a variety of different data processing activities by users, for example, customers who are largely unaware of the structure of the standard object types. Put another way, the data objects 102 are generally logical structures that can be modeled and then instantiated upon deployment to store particular data. In some instances, the data objects 102 may represent one or more business objects associated with the application platform 124 (and the instances thereof, or application 122) as described above. The data objects 102 may also be related to or store information related to the additional architectural elements of the application platform 124 or a specific application 122 as described above.

According to some embodiments, the developer (or other analyst) may use a model-driven development environment 116 to compose an application using models 104 of business logic or processes, data objects 102, user interfaces, and so forth without having to write much, if any, code. Moreover, these models can include or be different logical layers of abstraction including system-specific, system-independent, business-independent instances. Indeed, one of these logical layers may represent actual code or modules, whether source or executable, to assist developers. These layers of abstractions can include different domains that provide different views on the particular abstraction, including graphical interfaces, business processes or logic, and data flow. In some circumstances, some or all of these models 104 may conform to a particular metamodel or metadata infrastructure. To aid the developer, analyst, or other user working with the model 104, portions may be extracted from the (perhaps very large) model 104. A view of this extracted portion can then be presented to the requesting or another user, often via interface 142. The extracted portion of model 104 can be intersected or aggregated with extracted portions to generate a unified view on the subset. For example, the user may utilize a filter provided by modeling environment 116 to drill down to a more manageable subset. This example user may then provide customized criteria to focus on particular portions of this subset.

Memory 105, whether local or distributed, can also store a set of customization tables 106. The customization tables 106 may be used at application 122 runtime to store information associated with certain configurations or solutions 126 used in connection with the application 122. Information defining the configuration represented by the customer-specific solution 126 can be stored in the customization tables 106 prior to or at runtime, and the application 122 can consume that configuration information and integrate the data stored in the customization tables 106 into the particular implementation of the executed application 122. Further use of the customization tables 106 will be described later herein.

Some or all of the data objects 102, models 104, and information associated with or stored in the configuration tables 106 may be stored or referenced in a local or remote development or metamodel repository. This repository may include parameters, pointers, variables, algorithms, instructions, rules, files, links, or other data for easily providing information associated with or to facilitate modeling of the particular object. More specifically, each repository may be formatted, stored, or defined as various data structures in eXtensible Markup Language (XML) documents, text files, Virtual Storage Access Method (VSAM) files, flat files, Btrieve files, comma-separated-value (CSV) files, internal variables, one or more libraries, or any other format capable of storing or presenting all or a portion of the interface, process, data, and other models or modeling domains. In short, each repository may comprise one table or file or a plurality of tables or files stored on one computer or across a plurality of computers in any appropriate format as described above. Indeed, some or all of the particular repository may be local or remote without departing from the scope of this disclosure and store any type of appropriate data.

Server 108 may also include interface 117 for communicating with other computer systems, such as clients 110, over network 112 in a client-server or other distributed environment. In certain embodiments, server 108 receives data from internal or external senders through interface 117 for storage in memory 105 and/or processing by processor 120. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals. Interface 117 may allow communications across network 112 via a virtual private network (VPN), SSH (Secure Shell) tunnel, or other secure network connection.

Network 112 facilitates wireless or wireline communication between computer server 108 and any other local or remote computer, such as clients 110. Network 112 may be all or a portion of an enterprise or secured network. In another example, network 112 may be a VPN merely between server 108 and client 110 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least a portion of network 112 may facilitate communications between server 108 and at least one client 110. In other words, network 112 encompasses any internal or external network, networks, sub-network, or combination thereof operable to facilitate communications between various computing components in environment 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise and certain local or remote clients 110.

Client 110 is any computing device operable to connect or communicate with server 108 or network 112 using any communication link. At a high level, each client 110 includes or executes at least GUI 142 and comprises an electronic computing device operable to receive, transmit, process and store any appropriate data associated with environment 100. It will be understood that there may be any number of clients 110 communicably coupled to server 108. Further, “client 110,” “developer,” and “user” may be used interchangeably as appropriate without departing from the scope of this disclosure. Moreover, for ease of illustration, each client 110 is described in terms of being used by one user. But this disclosure contemplates that many users may use one computer or that one user may use multiple computers. As used in this disclosure, client 110 is intended to encompass a personal computer, touch screen terminal, workstation, network computer, kiosk, wireless data port, smart phone, personal data assistant (PDA), one or more processors within these or other devices, or any other suitable processing device. For example, client 110 may be a PDA operable to wirelessly connect with an external or unsecured network. In another example, client 110 may comprise a laptop that includes an input device, such as a keypad, touch screen, mouse, or other device that can accept information, and an output device that conveys information associated with the operation of server 108 or clients 110, including digital data, visual information, or GUI 142. Both the input device and output device may include fixed or removable storage media such as a magnetic computer disk, CD-ROM, or other suitable media to both receive input from and provide output to users of clients 110 through the display, namely, the client portion of GUI or application interface 142.

GUI 142 comprises a graphical user interface operable to allow the user of client 110 to interface with at least a portion of environment 100 for any suitable purpose, such as viewing transformed application, model, or model subset (view) data 144. As the models 104 are filtered, at least a viewable portion of the results 144 are presented using GUI 142. Generally, GUI 142 provides the particular user with an efficient and user-friendly presentation of data provided by or communicated within environment 100. More specifically, GUI 142 can include a modeling editor that presents views of models 104 based upon filters. The modeling editor can be connected with the modeling environment 116 (or other development environment) such that the modeling editor and/or the modeling environment 116 can automatically generate an application model (e.g., a model of an application that is being developed) from a graphical model and/or vice versa. The modeling editor can allow a user to freely choose graphical objects that can represent one or more development objects, or no development objects at all. The modeling editor can support representing different abstraction levels that correspond to a graphical model. For example, this modeling editor can support modeling a detailed view or an abstract view of a graphical model. Typically, the information that is represented in a graphical model can be freely edited. For example, a graphical model can be edited to include user-descriptions or business information that is not part of the development objects and/or relationships among development objects. Changes to development objects and/or relationships among development objects can be automatically reflected in an associated graphical model, and/or vice versa. Accordingly, GUI 142 may comprise a plurality of customizable frames or views having interactive fields, pull-down lists, and buttons operated by the user. GUI 142 may also present a plurality of portals or dashboards. For example, GUI 142 may display a portal that allows developers or information managers to view, create, and manage data objects 102 or models. GUI 142 is often configurable, supporting a combination of tables and graphs (bar, line, pie, status dials, etc.) and is able to build real-time dashboards. It should be understood that the term “graphical user interface” may be used in the singular or in the plural to describe one or more graphical user interfaces and each of the displays of a particular graphical user interface. Indeed, reference to GUI 142 may indicate a reference to the front-end or a component of any application or software, as well as the particular interface accessible via client 110, as appropriate, without departing from the scope of this disclosure. Therefore, GUI 142 contemplates any graphical user interface, such as a generic web browser or touchscreen, that processes information in environment 100 and efficiently presents the results to the user. Server 108 can accept data from client 110 via the web browser (e.g., Microsoft Internet Explorer or Mozilla Firefox) and return the appropriate HTML or XML responses to the browser using network 112.

While FIG. 1A is described as containing or being associated with a plurality of components, not all components illustrated within the illustrated implementation of FIG. 1A may be necessary in each alternative implementation of the present disclosure. Additionally, one or more of the components described herein may be located external to environment 100, while in other instances, certain components may be included within or as a portion of one or more of the other described components, as well as other components not described. Further, certain components illustrated in FIG. 1A may be combined with other components, as well as used for alternative or additional purposes in addition to those purposes described herein.

FIG. 3A is a flowchart illustrating an example method for generating a business adaptation catalog model associated with a particular solution 126 and its associated BAC 128. At a high-level, method 300 can access one or more of the BACs 128 associated with the various solutions 126, and using the information stored within or associated with that specific BAC 128, generate a model representing the various business entities stored in the BAC 128, as well as the relationships between those entities. Before describing method 300 in detail, however, an example BAC 315 will be described.

Generally, BACs 128 associated with one or more solutions are available only as a text-based files, without a general model created to provide customers and developers the ability to clearly understand and review the specific business configurations associated with each solution 126 and its BAC 128. For example, FIG. 3B illustrates an example of a stored BAC 128/315 prior to execution of method 300. As illustrated, example BAC 315 of FIG. 3B may comprise two distinct portions: i) a tree-based structure 317 defining the hierarchical representation of the business elements within the example BAC 315 and ii) a constraint table 319 providing a list of constraints between the various business elements. In certain implementations, both the tree-based structure 317 and the constraint table 319 of the example BAC 315 may be formatted, stored, or defined as various data structures, including eXtensible Markup Language (XML) documents, text files, flat files, comma-separated-value (CSV) files, or any other format capable of storing or representing all or a portion of the business elements and their associated constraints.

In the tree structure 317 storing the hierarchical representation of the BAC's business elements, the highest level of the tree illustrated is the business area. In the present example, the BAC 315 includes Business Area 1 (321) and Business Area 2 (351). Although illustrated as including two business areas, each BAC may include more than two business areas, or in some instances, only a single business area. The number of business areas included in a particular BAC is determined by the scope of functionality associated with the application 122 that is desired to be exposed to customers via this BAC 128/315. For instance, if a particular BAC 128 is limited to customers sales alone, then only one business area may need be included within that BAC 128. However, if the BAC 128 is designed to cover a wide-range of functionality, then the BAC 128/315 may be designed to include additional functionality of the application 122 that is relevant to the desired business activities and business areas.

Focusing on Business Area 1 (321), the business area includes two business packages, Business Package 1A (323) and Business Package 1B (333). Again, the number of business packages included in a particular BAC 128/315 is determined by the solution's 126 intended use and the customer's specific needs. Each business package can then be associated with one or more business topics. For instance, Business Package 1A (323) includes two business topics, Business Topic 1AA (325) and Business Topic 1AB (327), while Business Package 1B also includes two business topics, Business Topic 1BA (335) and Business Topic 1BB (349).

Each business topic can then be associated with one or more business options, each business option representing the lowest level of granularity in the BAC 315 and providing the customer (or developer) with specific options related to the business area, business package, or business topic with which the business option is associated. The particular information associated with each business option can be set or manipulated during the design and scoping of the BAC 315 itself or during the design and definition of the associated solution 126. As illustrated in FIG. 3B, Business Topic 1AB (327) includes one business option, Business Option 1ABA (329). Business Topic 1BA (335) of Business Package 1B (333) is associated with a set of business options, Business Option 1BAA (337), Business Option 1BAB (341), and Business Option 1BAC (345). While FIG. 3B illustrates business options as only associated with business topics, in some instances, business options may be associated with one or more business packages directly in order to define options specific directly to the associated business package, and not to a business topic associated with the business package.

As illustrated, each business option is associated with a particular business configuration (BC) set (i.e., Business Option 1ABA (329) is associated with BC Set 1 (331), Business Option 1BAA (337) with BC Set 2 (339), Business Option 1BAB (341) with BC Set 3 (343), and Business Option 1BAC (345) with BC Set 4 (347)). These attached BC sets are table entries that define the particular values associated with a particular option. In general, each BC set represents a collection of data sets of configuration data associated with its particular business option. For instance, if Business Option 1ABA (329) represents a choice related to the document number to be assigned to a particular invoice, then BC Set 1 (331) can represent the range of number values associated with the selection of that business option. At runtime, if a particular business option (e.g., Business Option 1ABA (329)) is activated in or as a part of the associated solution 126, the information defined by the business options' associated BC set (e.g., BC Set 1 (331)) will be consumed or read at runtime into the customization table 106 of memory 105. The information stored in the customization table 106 will then be accessed during execution of the related instance of application 122 and used to provide the customer-specific data associated with the particular solution 126.

As further illustrated in FIG. 3B, each BAC 315 includes or is associated with a constraint table 319 defining the relationships between various business elements of the BAC 315. In some instances, when one business element is activated, the constraint table may include a constraint stating that a second business element must be activated as well when the first business element is selected. A number of constraint types and logic may be used for a particular BAC 315, and a portion of those constraints will be described herein. In general, the constraint between various BAC elements helps ensure that the integrity of each particular solution 126 is maintained as the solution 126 is designed or scoped. Stated differently, the constraints ensure that the business elements selected for a particular solution 126 are able to perform their necessary or intended functions by requiring or suggesting the selection or activation of other, related business elements. For instance, if a particular business package is selected from the BAC 315 as part of the solution 126, certain other business packages, topics, or options may be required based on the known actions and interactions of the particular business package with the other business elements. In some situations, for a particular business element to be selected or included in a solution 126, another business element must first be selected or activated before the particular business element is allowed to be included in the solution 126.

The constraint table 319 of FIG. 3B illustrates several examples of the constraints (and constraint notation) currently used within the BAC 315. In many implementations, the constraint table 319 may be stored solely as a text file, with possibly thousands of various constraints defined for the business elements of each BAC 315. The application 122, the solution 126, or the modeling environment 116 may use a parsing and/or rule module (not illustrated in FIG. 1A) to interpret, implement, and enforce the constraints included in the constraint table 319. FIG. 3C illustrates an example set of modeling notations used to represent the various example constraints described in connection with the constraint table 319 of FIG. 3B. Once the example constraints listed in FIG. 3B have been described below, reference to their example representations in FIG. 3C will follow. As a note, while FIG. 3C provides example representations of the constraints from FIG. 3B, other suitable elements or notations may be used to represent the constraints in alternative implementations.

Element 353 of the constraint table 319 provides an example of an “activates” constraint included within the BAC 315. The example “activates” constraint may be understood to mean that if Business Package 1A is selected, then Business Topic 1AA is selected. Further, the selection of Business Package 1A requires that Business Topic 1AA is selected, or that the selection of Business Package 1A activates Business Topic 1AA. Additionally, it can be understood that the selection of Business Package 1A locks the selection of Business Topic 1AA, in that Business Topic 1AA cannot be deselected by the developer or customer as long as Business Package 1A is selected. Element 353A of FIG. 3C provides a visual representation of the “activates” constraint described in element 353. As shown therein, the “activates” constraint is represented by a solid line with a solid tip originating at Business Package 1A with the tip pointing to Business Topic 1AA to indicate that the Business Package 1A activates the Business Topic 1AA.

Element 354 of the constraint table 319 provides an example of a “depends on” constraint as included within the BAC 315. The example “depends on” constraint may be understood to mean that if Business Topic 1AB is deselected, then Business Option 1ABA cannot be selected. Generally, this relationship may be used to enforce the separation between business packages and business topics (i.e., not allowing a business topic within a business package to be selected if the business package itself is not selected), as well as between different business options (i.e., not allowing a business option within a business topic to be selected if the business option itself is not selected). In other words, the “depends on” constraint may be used to enforce the hierarchical or linear ordering of business packages and topics. Element 354A of FIG. 3C provides a visual representation of the “depends on” constraint described in element 354. As shown in FIG. 3C, the “depends on” constraint is represented by a solid line with an open tip. The line begins at a first business element that depends on the second business element, with the arrow pointing from the first business element to the second business element. In the example of element 354A, the line begins at Business Option 1ABA, and ends with the open tip pointing to Business Topic 1AB, indicating Business Option 1ABA's dependence upon Business Topic 1AB.

Element 355 of the constraint table 319 in FIG. 3B provides an example of a “subordinate” constraint as included within the BAC 315. The example constraint may be understood to mean that if Business Package 1A is selected then Business Option 1ABA is selected, otherwise, Business Option 1ABA is deselected. The “subordinate” constraint may be understood as a combination of the previously described “activates” and “depends on” constraints. In other words, when the Business Package 1A is selected, Business Option 1ABA is also selected or activated. In addition, Business Option 1ABA depends on Business Package 1A, such that if Business Package 1A is not selected, then Business Option 1ABA is not selected either. The subordinate constraint is illustrated by element 355A in FIG. 3C. As described, the subordinate constraint is a combination of the “activates” and “depends on” constraint, and can be illustrated as such by showing representations of both the “activates” constraint and the “depends on” constraint as two arrows. In some instances, the two lines may be combined to create a unique representation of the subordinate constraint, wherein a single solid line contains an open tip towards the controlling business element (illustrating the depends on constraint of the second element upon the first element) and a solid tip towards the controlled business element (illustrating the “activates” constraint of the first element causing the activation of the second element). Both representations are illustrated in element 355A.

Element 356 of the constraint table 319 provides an example of a “suggests” constraint as included within the BAC 315. The example constraint may be understood to mean that when Business Topic 1AB is selected, then Business Option 1ABA is also selected. However, the “suggests” constraint does not cause Business Option 1ABA to be locked, unlike the “activates” constraint described with regard to element 353. In the BAC 315, the “suggests” constraint can be used to add the default rules to the business elements. However, the customer or developer is not required to keep these rules, and may remove the selection of Business Option 1ABA after the selection of Business Topic 1AB activates it based on the “suggests” constraint. The “suggests” constraint can be used for relationships or constraints that most solutions will follow based on either their business logic or standard procedures, but that is not required to retain the integrity of the solution 126. Element 356A of FIG. 3C provides a visual representation of the “suggests” constraint described by element 356, illustrating the “suggests” constraint as a dashed line with a solid tip pointing towards the element suggested by the activation of another element (herein, the Business Option 1ABA suggested by the activation of Business Topic 1AB).

Elements 357, 358, and 359 of the constraint table 319 provide examples of Boolean operators as used in the constraint table 319. The illustrated Boolean operators are “AND” and “OR” operations, although more complex and additional Boolean operations can be included in certain implementations. Further, Boolean operators can be chained or reused to generate complex constraint expressions in the constraint table 319.

Element 357 provides an example of an “OR” Boolean operator as included within the BAC 315 combined with an “activates” constraint from element 353. The example constraint states that if either (1) Business Option 1BAA is selected or (2) Business Option 1BAB is selected, then Business Option 1BAC is also selected. In other words, the constraint is triggered if either of the preconditions of the constraint are present. Element 357A of FIG. 3C illustrates two versions of the example “OR” constraint. In the first example, a circle labeled “OR” is used to indicate the Boolean expression, and solid line connections from the two business elements representing the preconditions to the “OR” constraint are provided, with a solid dot represented at the connection to each precondition business element. Here, those connections are to Business Option 1BAA and Business Option 1BAB. From the “OR” operator, the line representing an “activates” constraint is provided to indicate that Business Option 1BAC is activated if either Business Option 1BAA or Business Option 1BAB is also activated. Additionally, “OR” constraints (acting as conditions, not as consequences) can be split into simpler constraints because the relationships between the precondition business elements are independent of each other. In that case, both Business Option 1BAA and Business Option 1BAB may be visualized as having individual activate constraints for Business Option 1BAC. If either of the precondition options are activated, then Business Option 1BAC will be activated.

Element 358 of FIG. 3B illustrates a first example of an “AND” Boolean operator as included within the BAC 315 combined with an “activates” constraint from element 353. The example constraint requires that if both (1) Business Topic 1BA is selected and (2) Business Option 1BAA is selected, then Business Option 1BAB is selected. In other words, the constraint is triggered only when both of the preconditions of the constraint are present. If this instance, if either of Business Topic 1BA or Business Option 1BAA is not selected, then Business Option 1BAB will also not be selected. Element 358A of FIG. 3C illustrates an example of a visualization of the “AND” constraint. Similar to the “OR” constraint notation of element 357A, the “AND” constraint can be modeled by a circle labeled “AND” indicating the use of the “AND” Boolean expression. Connections to the business elements of the precondition can be represented by solid lines to the “AND” operator with solid dots attached to the precondition business elements. On the other side of the “AND” operator, the proper constraint notation or representation can be added. Here, element 358A includes an arrow from the “AND” operator to the Business Option 1BAB representing the “activates” constraint of element 358.

Element 359 illustrates a second example of an “AND” Boolean operator as included within the BAC 315 and combined with a “depends on” constraint from element 354. Although the Boolean operator listed in the constraint is an “OR” operator, the constraint can be visualized as an “AND” constraint, because Business Option 1BAB depends on both Business Topic 1BA and Business Topic 1BAA. Stated differently, if either of Business Topic 1BA or Business Topic 1BB are not selected, then Business Option 1BAB will not be selected either. Therefore, Business Option 1BAB depends on both of the aforementioned business topics to be activated. Element 359A of FIG. 3C illustrates an example visualization of the “AND” operator associated with the “depends on” constraint of element 359 in FIG. 3B. As described by the constraint, Business Option 1BAB depends on both Business Topic 1BA and Business Topic 1BB. Therefore, the constraint can be modeled using a “depends on” arrow starting at Business Option 1BAB and pointing to an “AND” operator as shown, with the “AND” operator connected to Business Topic 1BA and Business Topic 1BB. While this visualization is correct, the constraint can be split into two simpler constraints by understanding the meaning of the “AND” operator. Because Business Option 1BAB depends on both Business Topic 1BA and Business Topic 1BB, and therefore cannot be activated without both topics being activated, an alternative representation of the constraint may include two “depends on” arrows extending from Business Option 1BAB, one to Business Topic 1BA and one to Business Topic 1BB. This representation retains the logic of the original visual representation, while making clear that the Business Option 1BAB depends on both business topics.

Element 360 of FIG. 3B illustrates an example of a logical “NOT” constraint as included in BAC 315. The example constraint may be understood to mean that if Business Topic 1AA is selected, then Business Topic 1AB will be deselected. This constraint can be used where two particular business elements (e.g., two related, but incompatible, business options) are mutually exclusive and cannot both be activated in a particular solution. Element 360A of FIG. 3C illustrates a representation of the “NOT” constraint using a circle labeled “NOT” to indicate the Boolean expression, and solid line connections to the precondition business element of Business Topic 1AA. The “NOT” constraint reads that Business Topic 1AA activates not Business Topic 1AB (i.e., it deactivates Business Topic 1AB).

Having described the BAC 315, along with its business element data structure 317 and associated constraints 319, method 300 may now be described in full with reference to particular examples in FIGS. 3B and 3C. At 302, a particular solution 126 is identified in method 300. In some implementations, a plurality of solutions 126 may be associated with a particular environment 100. In one implementation, identifying the particular solution 126 may comprise a manual selection of a solution 126 from a developer or customer associated with environment 100 for which to model the associated BAC 128. In another implementation, method 300 may be an automatic process applied to all solutions 126 associated with environment 100, such that method 300 is performed for each solution 126 included within or associated with the environment 100.

At 304, method 300 identifies the particular BAC 128 associated with the identified solution 126. As previously described, each solution 126 may be associated with its own unique BAC 128, while in other instances, each of the plurality of solutions 126 associated with a particular environment 100 may share a single, common BAC 128 that defines the available business elements and constraints for each solution 126. In other implementations, a plurality of shared BACs 128 may be shared among multiple solutions 126. Sharing one or more common BACs 128 may allow developers and customers to benefit from previous work done by others or for other solutions 126 in developing a comprehensive and integrity-checked BAC 128. By using previously-defined BACs 128 for new solutions 126 (based on the same application platform 124 or application instance 122), time and resources can be saved without requiring duplicative efforts by different developers. In still other instances, a pre-defined BAC 128 may be copied and associated with a new solution 126, allowing the developer or customer to take a previously-defined BAC 128 and make changes where needed to the copied BAC 128 without requiring the full-development of a new BAC 128. To identify the BAC 128 associated with the identified solution 126, method 300 checks the solution 126 for information defining the particular BAC 128 associated with that solution 126. In some instances, a portion of the solution 126 may be parsed to determine the appropriate BAC 128 linked to or associated with the solution. In other instances, a database table or text file storing defined relationships between one or more solutions 126 and one or more BACs 128 may be stored in memory 105 of FIG. 1A, and referenced by method 300 after a particular solution 126 is identified at 302.

Once the appropriate BAC 128 is identified, at 306 information defining one or more business elements from the identified BAC 128 is retrieved from the identified BAC 128. The information may be retrieved from the identified BAC 128 by reading or accessing the data structure of the business elements included within the identified BAC 128, such as by the modeling tool 140 or by one or more of the modeling APIs 118 included in the modeling environment 116. Additionally, another software module or sub-module of one of the illustrated components of environment 100 may be used to read the tree structure (e.g., 317 illustrated in FIG. 3B) to determine the hierarchical relationships between one or more of the business elements within the identified BAC 128.

At 308, method 300 analyzes the various constraints associated with the business elements retrieved from the tree structure of the identified BAC 128. For instance, the constraint table 319 illustrated in FIG. 3B may be accessed and read by the modeling tool 140, modeling APIs 118, other software in the modeling environment 116, or other software not illustrated in FIG. 1A capable of reading, understanding, and modeling the various relationships defined by the BAC 128. The information read from the constraint table 319 may be stored temporarily in memory 105 as the modeling tool 140 or other software coordinates the generation of the appropriate BAC model. In some instances, analyzing the constraints of the BAC 128 may be performed simultaneously with the retrieval of information defining the one or more business elements from the identified BAC 128. For example, as information related to Business Package 1A (323) is retrieved from the BAC's 128 tree data structure 317, constraint information associated with Business Package 1A (323) may be simultaneously retrieved from the constraint table 319.

At 310, method 300 generates a BAC model representing the plurality of business elements associated with the BAC 128 and the constraints associated with those business elements. The information retrieved from the combination of 306 and 308 can be combined, or integrated, to generate the model in the modeling environment 116. For example, the information retrieved from the data structure 317 identifying the various business elements associated with the BAC 128 can be modeled using a hierarchical model, wherein the hierarchical relationships are represented by a model illustrating the hierarchical relationship using containment visualizations. For instance, turning to FIG. 3D, an example BAC model 365 has been generated. As illustrated, the BAC model 365 represents a portion of the business elements included within the BAC's data (or tree) structure 317 of FIG. 3B. Specifically, the model 365 illustrates the elements included hierarchically underneath the business element Business Area 1 (321). As shown in FIG. 3B, Business Package 1A (323) and Business Package 1B (333) are separate business packages located within Business Area 1 (321). Each business package includes two business topics. As illustrated (and corresponding with the BAC tree structure 317), Business Package 1A includes Business Topic 1AA (325) and Business Topic 1AB (327), while Business Package 1B includes Business Topic 1BA (335) and Business Topic 1BB (349). Further, several of the business topics are illustrated as including one or more business options. For instance, Business Topic 1AB (327) includes Business Option 1ABA (329), and Business Topic 1BA (336) includes three business options: Business Option 1BAA (337), Business Option 1BAB (341), and Business Option 1BAC (345).

In addition to the visualization of the hierarchical relationships within the BAC 128, the BAC model 365 incorporates the constraints read from the BAC constraint table 319 and analyzed at 308 in order to provide a further visualization of the constraints present between the illustrated business elements. As a note, the constraints illustrated in FIG. 3D differ from the example constraints shown in the constraint table 319 of FIG. 3B. The constraints illustrated in FIG. 3D are meant to be an illustration of one example set of constraints associated with a particular example BAC 128. The constraints illustrated by the BAC model 365 are as follows:
Business Area 1 (321) activates Business Package 1A (323)—illustrated by arrow 368;
Business Area 1 (321) activates Business Package 1B (333)—illustrated by arrow 376;
Business Package 1A (323) suggests Business Topic 1AA (325)—illustrated by arrow 370;
Business Package 1A (323) activates Business Topic 1AA (325) or Business Topic 1AB (327)—illustrated by arrow and “OR” combination 372;
Business Topic 1AB (327) activates Business Option 1ABA (329)—illustrated by arrow 374;
Business Package 1B (333) activates Business Topic 1BA (335)—illustrated by arrow 378.

As discussed, these constraints are read from the BAC 128 associated with the model 365 and identified at 304. As a note, when a parent element activates a child element (i.e., where Business Area 1 (321) activates Business Package 1A (323)), drawing the appropriate or normal line from the parent to the child may be confusing or misleading, as well as cause overlaps with other constraint notations included within the BAC model 365. In order to minimize such confusion in the BAC model 365, lines representing a parent “activating” a child may be replaced by the short, diagonal arrow (as illustrated by elements 368, 374, 376, and 378) in lieu of the arrow normally connecting elements for an “activates” constraint. For instance (and as described above), arrow 368 indicates that Business Area 1 (321) activates Business Package 1A (323).

Thus, FIG. 3D illustrates the BAC model 365 generated for Business Area 1A (321) of the BAC 128. In alternative implementations, or in a different view of the model 365, other portions of the BAC model 365 can be viewed. For instance, other business areas (such as Business Area 2 (351) of the BAC 315) and the elements associated therewith may also be viewable in the BAC model 365. BAC model 365 represents one example view of the BAC model 365, and could include a plurality of additional business elements and constraints, including additional constraints representing the relationships between the currently illustrated business element. In some instances, changes to the BAC 315 on which the BAC model 365 result in a new version of the BAC model 365 being generated. In one example, the modeling environment 116 may update its models at predefined intervals to ensure that at certain times each BAC model 365 will be accurate. In another example, the modeling environment 116 may receive a notification that the underlying BAC 315 has been updated or changed, and upon receiving that notification, may regenerate or update the BAC model 365 associated with the relevant BAC 315. In still another example, a customer or developer may request the modeling environment 116 or another application or piece of software in environment 100 to regenerate the BAC model 365 at any particular time. For example, if that customer or developer has amended the underlying BAC 315, and no automatic regeneration is in place, the customer or developer may initiate method 300 such that the BAC model 365 is regenerated with up-to-date information on the business elements and constraints associated with the identified BAC 315.

At 312, the BAC model associated with the BAC of the identified solution is presented. In one instance, the BAC model (e.g., BAC model 365) can be presented to a user via GUI 142. Where the BAC model is too detailed to be presented clearly in its entirety, a selected or relevant portion of the BAC model may be presented in a particular view 144 to client 110. Further, presenting the BAC model may include storing the BAC model in memory 105 along with the other set of models 104 illustrated in FIG. 1A. In still other instances, presenting the BAC model at 312 may comprise exporting the information defining the BAC model into a documentation system. For instance, the information and models representing the BAC model may be used to automatically create documents explaining or describing the business elements and constraints of the modeled BAC (and solution 126) as illustrated in the generated BAC model. The BAC model may also be used to define the organization of documents within the documentation system based upon the business element hierarchy and constraints. Further, the BAC model may be used to create or generate figures for the documentation system, such as flowcharts, illustrations, and examples of the various constraints and relationships within the BAC model.

In still other instances, the BAC model generated at 312 can be used to define new solutions 126. To do so, customers or developers can review the newly modeled BAC and select various business areas, business packages, business topics, and business options which are to be a part of the solution 126. In general, customers and developers may know generally which business elements they will want to include in a specific solution 126. However, the complexity of knowing which additional elements are activated by, required by, suggested by, or have some dependence upon a specific element is not generally known. By using the generated BAC model to provide a clear understanding of the implications of each selection, customers and developers can create working solutions that provide the capabilities required by the customer's specific solution 126, including not only the general functionality associated with the solution, but also the additional functionality required to perform the desired functionality.

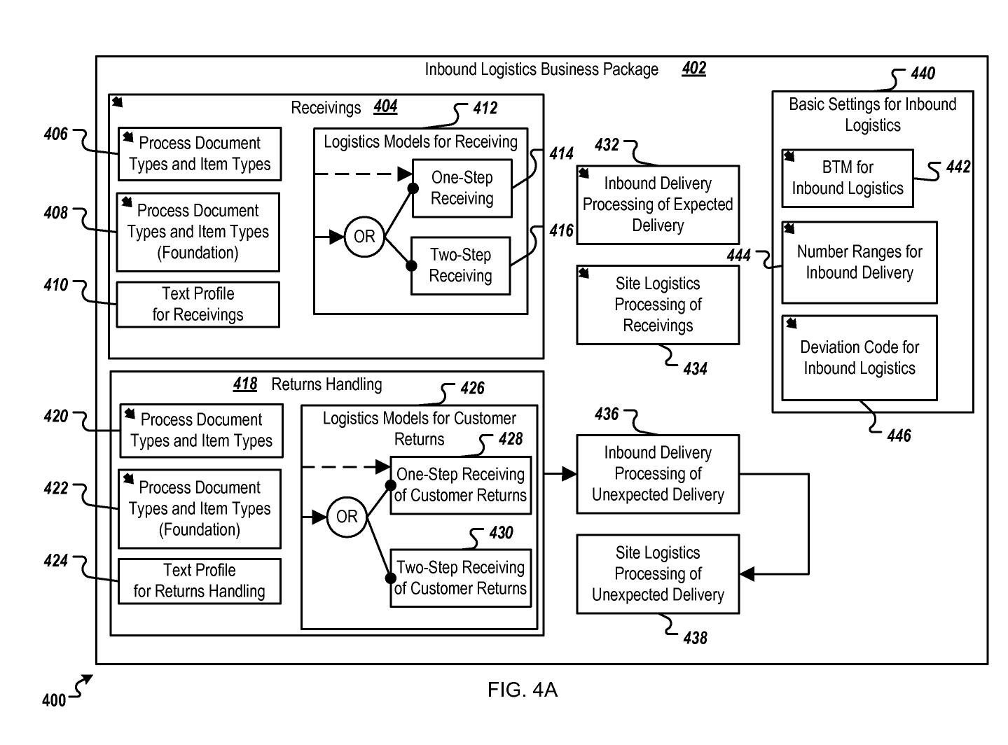

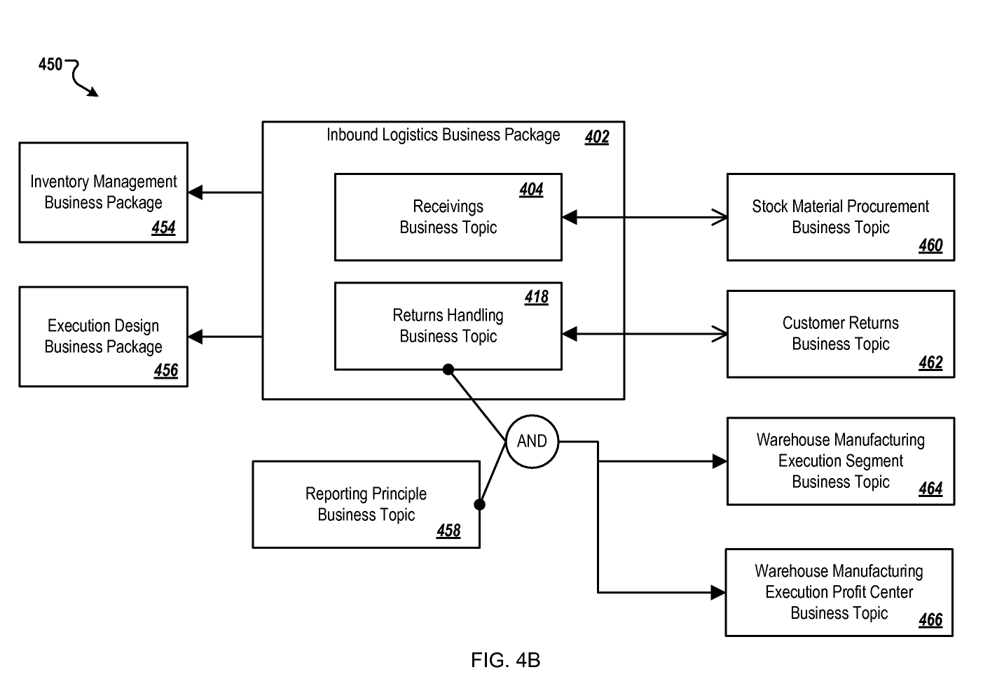

FIGS. 4A and 4B illustrate two example BAC models illustrating models specific to the Inbound Logistics business package, and as generated by method 300 based on information stored within a particular BAC 128 storing information defining the Inbound Logistics business package 402. The BAC model 400 of FIGS. 4A and 4B provides business users and technical users an understanding of the interactions between various business elements throughout the associated BAC, allowing all users to make informed decisions for the elements activated in a particular solution 126 without requiring a line-by-line analysis of a detailed text file to understand the effects certain activation choices have on external or remote elements in the BAC. The BAC model 400 of FIG. 4A illustrates the business elements internal to the Inbound Logistics business package 402, as well as the constraints associated with and relating those business elements. For instance, the Inbound Logistics business package 402 includes two business topics, Receivings 404 and Returns Handling 418. As shown, the Receivings business topic 404 is activated by the Inbound Logistics business package 402 when the package 402 is activated. However, the Returns Handling business topic 418 is not automatically activated when the Inbound Logistics business package 402 is activated, and must be activated by a particular solution 126 in order to be included at runtime. In addition to the Receivings business topic 404, the Inbound Logistics business package 402 activates the Inbound Delivery Processing of Expected Delivery business option 432 and the Site Logistics Processing of Receivings business option 434, along with the business options of the Basic Settings for Inbound Logistics business option group 440. Business option groups allow sets of related business options to be grouped together, allowing for decisions on activation and selection of the related business options to be made concurrently or in a set of related decisions. Business option groups have no semantics, but are primarily used for grouping the related business options. In the current BAC model 400, the Inbound Logistics business package 402 activates each of the business options in the group 440: BTM for Inbound Logistics business option 442, Number Ranges for Inbound Delivery business option 444, and Deviation Code for Inbound Logistics business option 446.

The Receivings business topic 412 include several business options, including Process Document Types and Item Types business option 406 (activated by the Receivings business topic 404), Process Document Types and Item Types (Foundation) business option 408 (activated by the Receivings business topic 404), and Text Profile for Receivings business option 410. Additionally, the Receivings business topic 404 includes a Logistics Models for Receiving business option group 412. The Logistics Models for Receiving business option group 412 includes a One-Step Receiving business option 414 and a Two-Step Receiving business option 416. The options are related, and the constraints defined for the business options show that only one of the two will be activated by the Receivings business topic 404 based on the “OR” operator included in the business option group. As shown by the dashed line, the Receivings business topic 404 suggests that the One-Step Receiving business option 414 is selected (and therefore selects the option 414 as the default value), but allows customers or developers to select the Two-Step Receiving business option 416 instead.

The Returns Handling business topic 418 includes its own set of business options: Process Document Types and Item Types business option 420 (activated by the Returns Handling business topic 418), Process Document Types and Item Types (Foundation) business option 422 (activated by the Returns Handling business topic 418), and Text Profile for Returns Handling business option 424. Additionally, the Returns Handling business topic 418 includes the Logistics Models for Customer Returns business option group 426, wherein the group 426 includes the business options of One-Step Receiving of Customer Returns 428 and Two-Step Receiving of Customer Returns 430. The Returns Handling business topic 418 activates one of the two business options 428 or 430, but suggests (or selects by default) the One-Step Receiving of Customer Returns business option 428. As illustrated in the BAC model 400, when the Returns Handling business topic 418 is activated, the Inbound Delivery Processing of Unexpected Delivery business option 436 is also activated, which in turn activates the Site Logistics Processing of Unexpected Delivery business option 438.

FIG. 4B illustrates a higher-level view 450 of the BAC model 400 illustrated in FIG. 4A, in which business elements and constraints external to but associated with the Inbound Logistics business package 402 as represented. Using the modeling environment 116, customers, developers, and other users may view the BAC model 400 at various levels of detail, from low-level (illustrating each of the business options associated with a particular business topic) to high-level (illustrating the relationships between various business packages and the global effects throughout the associated BAC because of the activation of a particular business package, as is illustrated in FIG. 4B). In some instances, these business packages may be associated with another business area outside the business area containing the Inbound Logistics business package 402. By illustrating these external relationships and constraints, customers and developers can understand the global effect of the activation of a particular business element as it pertains to all of the other business elements within the BAC. In other words, the combination of the BAC models 400 and 450 (as well as any number of other available views) can provide a transparent and clear understanding of the effect of the activation of certain elements in a particular solution 126, whereas prior to generation of the BAC models 400 and 450 (via method 300), only the text-based BAC 128 (or 315) existed, forcing customers and developers attempting to understand the detailed relationships between various business elements to search through the text-based descriptions of the various business elements and constraints (such as non-modeled BAC 315 illustrated and described in FIG. 3B).

Returning to FIG. 4B, the effects on elements external to the Inbound Logistics business package 402 are shown by the illustrated view of the BAC model 450. For example, when it is itself activated, the Inbound Logistics business package 402 activates both the Inventory Management business package 454 and the Execution Design business package 456. Further, the external BAC model 400 shows that the Receivings business topic 404 is subordinate to the Stock Material Procurement business topic 460, while the Returns Handling business topic is subordinate to the Customer Returns business topic 462. As previously described, when an element is subordinate to another (i.e., the Receivings business topic 404 is subordinate to the Stock Material Procurement business topic 460), it is activated when the superior element is activated, and can also not be activated when the superior element is not also activated. Therefore, in order to activate the Receivings business topic 404, the Stock Material Procurement business topic 460 must first be activated. The same is true for the relationship between the Returns Handling business topic 418 and the Customer Returns business topic 462. Additionally, the external BAC model 450 shows that if both the Returns Handling business topic 418 of the Inbound Logistics business package 402 and the external Reporting Principle business topic 458 are activated, then both the Warehouse Manufacturing Execution Segment business topic 464 and the Warehouse Manufacturing Execution Profit Center business topic 466 are also activated. In some instances, the BAC model 450 may only provide a portion or subset of the external relationships and constraints for the Inbound Logistics business package 402. Other views of the BAC model (other than 400 and 450) may provide additional business elements and relationships associated with the particular package 402. Additionally, similar BAC models will be available for each of the business packages included within a particular BAC 128. Therefore, for any business element, customers and developers (or any other interested user) can view and understand the myriad of relationships and constraints associated with any particular business element or sets of business elements within the BAC 128.

As previously described, the solution 126 consists of the application 122 upon which its BAC 128 is built. The business elements defined for a particular BAC 128 are related to the application 122, in that the business elements included within the BAC 128 correspond to various engineering entities in the application 122. As previously described, the architecture of the application 122 includes such engineering entities as process components, BPVTs, and business objects. The BPVTs provide variability to particular process components, in that each BPVT provides a different method of performing some action associated with its particular process component. BPVTs provide multiple representations of different, but typical ways of processing within a process component from a business point of view. In other words, BPVTs allow the same process component to play different roles during different operations or in different situations, allowing each process component to use one set of functionality in some situations, and another set of functionality in other situations. Whereas the BPVTs provide variability of processes, a new engineering entity is needed to add further variability to the application 122. To do so, a new application engineering entity is introduced—the configuration control.

In general, a configuration control defines a point in an engineering entity within the application 122 where variability of a function or data can be configured. Each configuration control is assigned to or associated with one BPVT, business object, or process component within the application 122 in order to document that entity's variability. Further, each configuration control is defined to refer to a specific configuration schema, where each configuration schema defining the format of the information associated with the configuration control. For instance, the configuration schema associated with a configuration control entitled Number Range may be a set of numbers in a particular format. In most cases, each defined configuration control is mapped to or associated with a particular business option from the BAC 128. However, only configuration controls required by a particular constraint must be mapped to the BAC 128. In some instances, only particular portions of the application 122 that are needed by the solution 126 (or end user) are associated with business elements. In those instances, certain configuration controls and other engineering entities may not be associated with business elements within the BAC 128.

Conversely, each business option carrying or associated with a business configuration set must be mapped to a configuration control. The configuration control is generally designed first, and the business option is later created to implement the variability provided by the configuration control. By mapping configuration controls to business options, a connection between the solution 126 utilizing the business option and the engineering entity of the application 122 utilizing the configuration control is created. In some instances, business options may also be mapped to or associated with BPVTs to provide connections between the particular business options and the associated BPVT. In both cases, the BC set associated or linked with the business option is then associated with the configuration control and/or BPVT. In other words, the business configuration data that each business option represents is associated with the particular application entity with which the business option is mapped. By doing so, a solution 126 can be created, and the appropriate business elements (including the business options) are selected. The BC set associated with each activated or selected business option is then stored in the configuration table 106 illustrated in FIG. 1A. At runtime, the configuration control associated with a particular business option can access the configuration table 106 to retrieve the BC set information stored there by the solution 126. The business configuration data associated with each BC set can then be used in connection with particular configuration controls to provide new business alternatives that make use of the variability provided by the particular configuration controls. This allows the business option associated with the configuration control to be selected or defined by a customer or end user associated with the solution 126. In other words, the customer or end user specifically defines the values associated with the mapped configuration control and, in turn, the operations of the solution 126.

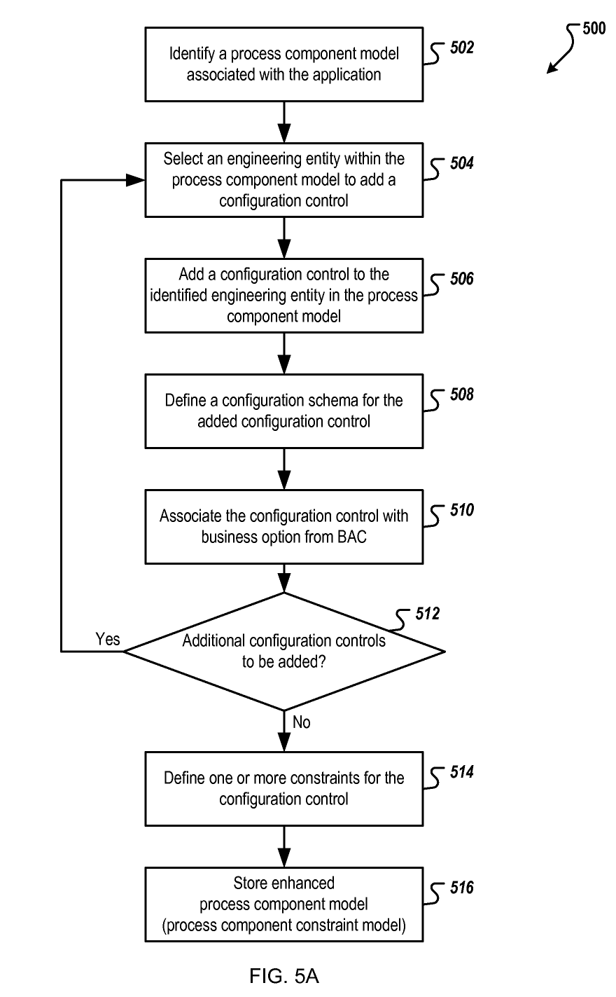

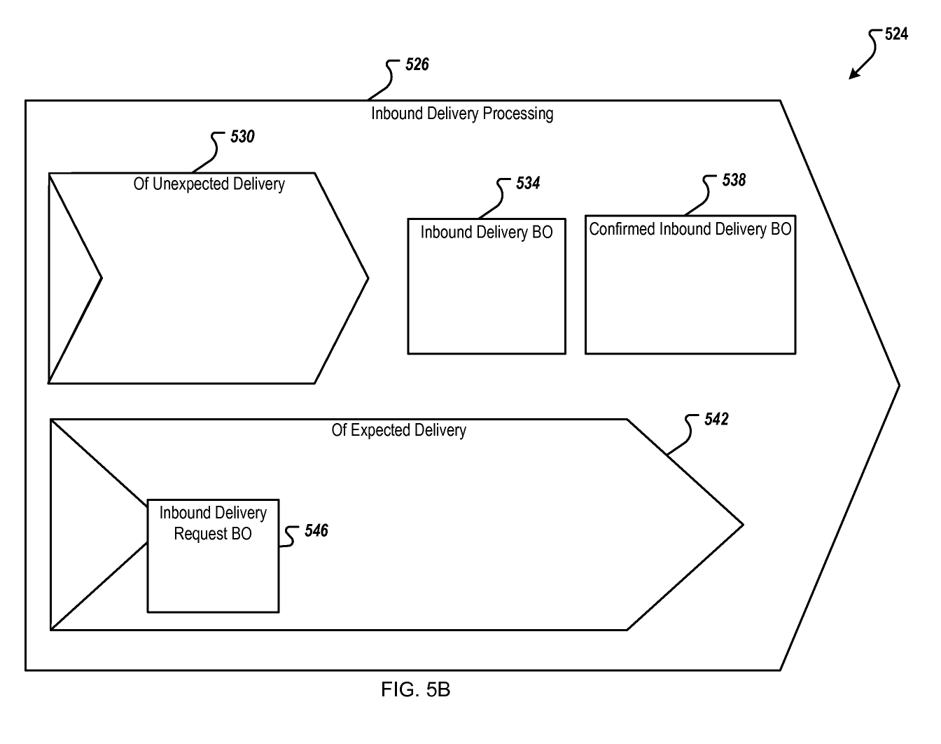

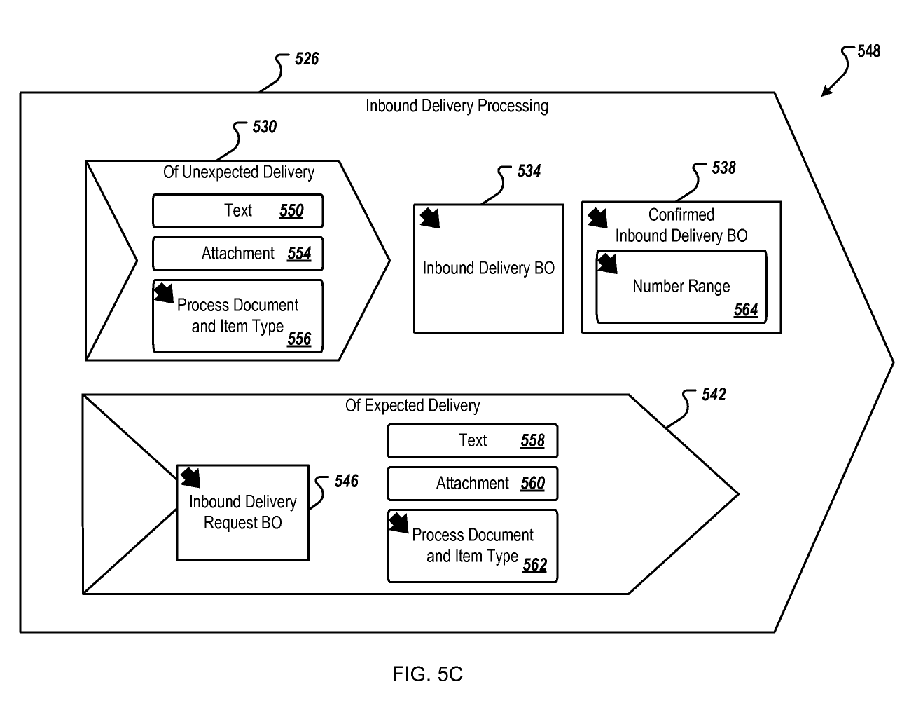

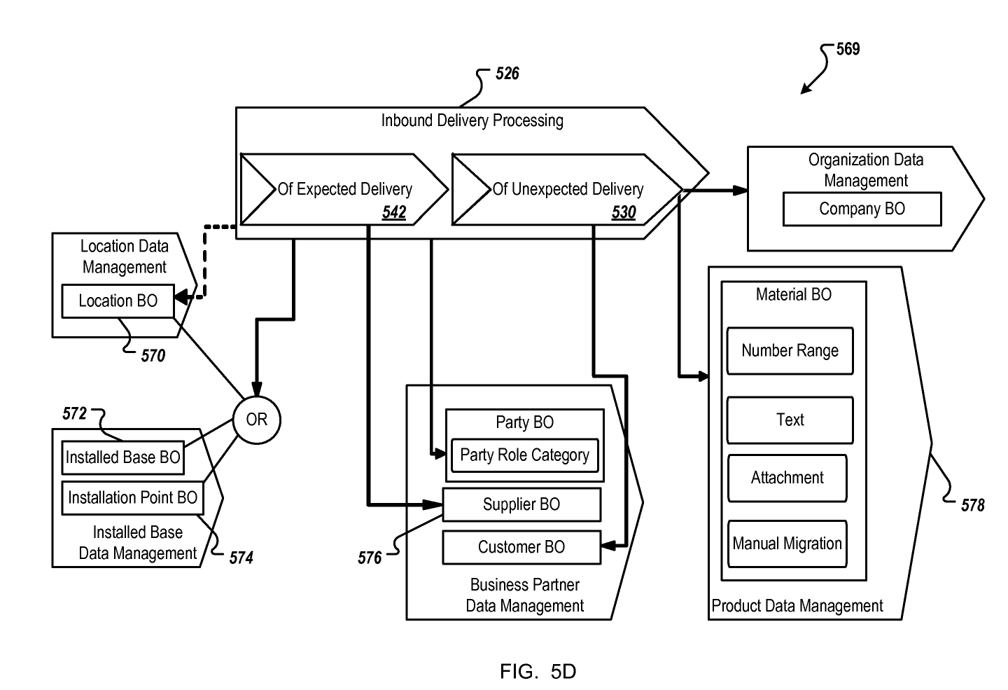

FIG. 5A illustrates an example method 500 for adding one or more configuration controls to the entities of an application 122 to allow for enhanced variability of the functions and data used during the application's runtime. At 502, a particular process component model associated with the application is identified. In general, the process component model may be identified by customer or developer wanting to add further variability to the application 122, sometimes in response to a desired solution 126. The process component model identified may be associated with a portion of a particular solution 126. For example, if a customer or developer is working on the Inbound Logistics business package 402 of FIG. 4A, configuration controls may be added to either the Inbound Delivery Processing process component model or the Site Logistics Processing process component model in order to maximize the opportunities for customization of the solution 126. FIG. 5B illustrates a process component model 524 of the Inbound Delivery Processing process component 526 prior to the addition of any configuration controls. The Inbound Delivery Processing process component 526 is modeled as comprising an Inbound Delivery business object 534, a Confirmed Inbound Delivery business object 538, an Of Unexpected Delivery BPVT 530, and an Of Expected Delivery BPVT 542 (which itself includes an Inbound Delivery Request business object 546). The model of the process component 526, which includes the BPVTs and business objects, may be retrieved from the set of models 104 stored in memory 105. Specifically, the process component model may be retrieved manually by the customer or developer performing method 500 by selecting the process component model from a list of models presented via the GUI 142. In some instances, a business element, such as a business package, may be identified in the BAC 128 and known to correspond to a particular process component. By creating a solution 126 utilizing an associated business element, the modeling environment 116 may provide the related process component model to the customer or developer associated with the solution 126 in order to enhance the appropriate process component model 524 with one or more configuration controls.

Once the appropriate process component (or process component model) has been identified, at 504 a particular entity within the identified process component is selected or identified for which to add a configuration control. As previously described, configuration controls can be associated with either a process component, a BPVT, or a business object. Thus, any of the entities illustrated in the process component model 524 of FIG. 5B could be selected for adding a configuration control. The selection may be made via the GUI 142 representing the modeling environment 116 using the modeling tool 140. In some instances, selecting the entity may comprise activating (e.g., by single mouse-click, double mouse-click, or right mouse-click) the appropriate application entity provided in the identified process component model 524.

A configuration control is added to the selected entity at 506. For example, a new configuration control can be added to the model 524 by selecting (i.e., using drag-and-drop from a menu provided in the modeling environment 116) a visual representation of the configuration control into the process component model 524. In those instances, configuration controls may be uniquely identified by a particular graphical image or figure located in a menu associated with or available from the modeling environment 116. When the configuration control is added, the configuration schema for the configuration control, which defines the type of information associated with the configuration control, can be defined at 508. When the configuration control is added to the selected entity and its configuration schema is selected, the configuration control can be named according to its schema and associated entity. For instance, a configuration control defining the text values associated with a business object may be named “Text for <Business Object>,” or another suitable name. In some instances, certain configuration controls may be used for a plurality of application entities. In those instances, although only one configuration control is defined, each instance can be uniquely identified with the application entity it is associated with. For instance, a configuration control named Number Range may be used for a plurality of application entities where the configuration control is used to define a number range associated with the associated entity. Each configuration control is linked to the particular entity in which it is defined, and is provided a unique number or identifier associated with that instance of the configuration control. Thus, at runtime, when the information associated with the configuration control is accessed in the configuration table 106, the Number Range configuration control will retrieve the BC set or information associated with the unique identifier provided for that particular configuration control. Even in instances where a plurality of configuration controls with the same name are used and data is provided to the configuration tables, each individual configuration control will be able to access the configuration data corresponding to that particular configuration control.

FIG. 5C illustrates the Inbound Delivery Processing process component 526 after several configuration controls have been added to the component's 526 various entities. For example, the Of Unexpected Delivery BPVT 530 includes a Text configuration control 550, an Attachment configuration control 554, and a Process Document and Item Type configuration control 556. The Confirmed Inbound Delivery business object 538 includes a Number Range configuration control 564. The Of Expected Delivery BPVT 542 includes a Text configuration control 558, an Attachment configuration control 560, and a Process Document and Item Type configuration control 562. As an example of what the configuration controls describe, the example of the Confirmed Inbound Delivery business object 538 and its Number Range configuration control 564 is analyzed. The configuration control inside the business object 538 indicates that the business object 538 is configurable, and that each Confirmed Inbound Delivery is a document represented by the business object 538. Based on the Number Range configuration control 564, it is shown that each document is numbered upon creation. Thus, the Number Range configuration control 564 determines and defines the specific number ranges used to number each newly created Confirmed Inbound Delivery document. In another example from FIG. 5C, the Of Expected Delivery BPVT 542 and the Of Unexpected Delivery BPVT 530 both include a configuration control entitled Text (558 and 550, respectively). Each Text configuration control can be configured to the particular type of text associated with the related BPVT. For example, the text associated with an unexpected inbound delivery may differ from the text associated with an expected delivery, as the two deliveries may have originated from different locations. For instance, the Of Expected Delivery BPVT 542 may be associated with internal receivings and some known internal process, while the Of Unexpected Delivery BPVT 530 may be associated with customer returns that may be provided in one or more unknown or varying forms. Thus, when the Expected Delivery BPVT 542 is used, one set of text is appropriate, while when the Unexpected Delivery BPVT 530 is used, another set of text may be appropriate. Thus, configuration controls provide varying control to application and solution developers to provide customized solutions based on the particular circumstances of certain situations or that are used for certain solutions.

At 510, each configuration control is associated with a particular business option from an associated BAC 128. This association can be made by mapping a related business option to the newly added configuration control. For example, the Process Document Types and Item Types business option 406 illustrated in the Inbound Logistics business package 402 of FIG. 4A may correspond with a Process Document and Item Type configuration control added to the process component 526. After each configuration control is added to the process component, method 500 determines whether additional configuration controls are to be added at 512. If it is determined that additional configuration controls are to be added, then method 500 returns to 504 where another (or the same) entity is selected within the process component for adding a new configuration control. If it is determined that no additional configuration controls are to be added, then method 500 continues at 514, where one or more constraints can be added to the process component model. Constraints can be defined for both the newly defined configuration controls, as well as any other entity within the process component model. These constraints can be used to define the required, suggested, or dependent relationships among the various entities of a process component model, as well as entities external to the particular process component model associated with the added configuration control. The application entity constraints, like those of the BAC, define the integrity of the application. If certain entities are required by the application (or portions of the application) to execute properly, those requirements can be defined using the constraints added at 514.

FIG. 5C illustrates a process component model 548 that includes a plurality of constraints. Constraints can be defined for both the configuration controls added to the process component and its related entities, as well as to the entities themselves. As constraints and configuration controls are added to the process component model, the model can be described as a process component constraint model 548. In the illustrated example of FIG. 5C, certain entities of the Inbound Delivery Processing process component 526 now include constraints defining the integrity of the application 122, as shown by the arrows located in the top left of the entities. These arrows indicate a parent-child dependency according to the hierarchy of the application entities. For instance, if the Of Unexpected Delivery BPVT is activated in the application 122, then its child, the Process Document and Item Type configuration control 556, is required to be activated as well. Further, if the Inbound Delivery Processing process component 526 is activated, then its children, the Inbound Delivery business object 534 and the Confirmed Inbound Delivery business object 538, must also be activated. The Number Range configuration control 564 is activated when the Confirmed Inbound Delivery business object 538 is activated. Thus, by an indirect constraint, when the Inbound Delivery Processing process component 526 is activated, the Number Range configuration control 564 of the Confirmed Inbound Delivery business object 538 is also activated. When the Of Expected Delivery BPVT 542 is activated, the Inbound Delivery Request business object 546 and the Process Document and Item Type configuration control 562 are also activated based on the defined constraints in the illustrated example of FIG. 5C. In other words, if the application 122 attempts to execute without one of these required constraints, the application 122 will fail to perform as designed, and in some case, will fail to execute at all.

Additional constraints other than those illustrated in FIG. 5C can be used or illustrated for the application's engineering entities. For example, FIG. 5D illustrates an example model 569 of external (or cross-component) constraints associated with the inbound delivery processing component 526, as well as the external constraints for the Of Expected Delivery BPVT 542 and the Of Unexpected Delivery BPVT 536. For instance, the constraints of FIG. 5D illustrate the constraints associated with the activation of the Inbound Delivery Processing process component 526. For example, when the Inbound Delivery Processing process component is activated, the model of FIG. 5D indicates that the Location business object 526 (of the Location Data Management process component), the Installed Base business object 526, or the Installation Point business object several external entities must also be activated. Further, a “suggests” constraint indicates that when the Inbound Delivery Processing process component 526 is activated, the Location business object 570 is also activated (although it is not required to stay activated). While the Inbound Delivery Processing process component 526 is associated with various other external constraints, so are the Of Expected Delivery BPVT 542 and the Of Unexpected Delivery BPVT 530. As an example, activation of the Of Expected Delivery BPVT 542 activates the Supplier business object 576 of the Business Partner Data Management process component, while the Of Unexpected Delivery BPVT 530 activates, for example, the Product Data Management process component 578. As illustrated in FIG. 5D, other process components and business objects can be activated in accordance with the activation of the Inbound Delivery Processing process component 526, the Of Expected Delivery BPVT 542, and the Of Unexpected Delivery 530. By adding these or similar constraints (from FIGS. 5C and 5D) between the application's various engineering entities, the integrity of the of the application 122 is ensured such that errors based on conflicting (or contradictory) application entities, as well as errors based on missing required entities, can be avoided. Additionally, constraints defined in the process component constraint models (such as process component constraint model 548 or cross-component model 569) can be used to verify and/or generate the constraints between certain business elements of a particular BAC 128 based on their association with the application 122.

Once the constraints have been defined for the configuration controls and the other entities within the process component, at 516 the newly defined process component constraint model (e.g., process component constraint model 548) is considered created, and may be stored with the other sets of models 104 in memory 105. Additionally, the process component constraint model can be presented to a user via GUI 142. Further, at least a portion of the information associated with the process component constraint model may be exported the into a documentation system. For instance, the information and models representing process component constraint model may be used to automatically create documents explaining or describing the application entities and constraints illustrated in the process component constraint model. Still further, the process component constraint model may also be used to define the organization of documents within the documentation system based upon the application entity and configuration control hierarchy and related constraints. The process component constraint model may be used to create or generate figures for the documentation system, such as flowcharts, illustrations, and examples of the various constraints and relationships within the process component constraint model.

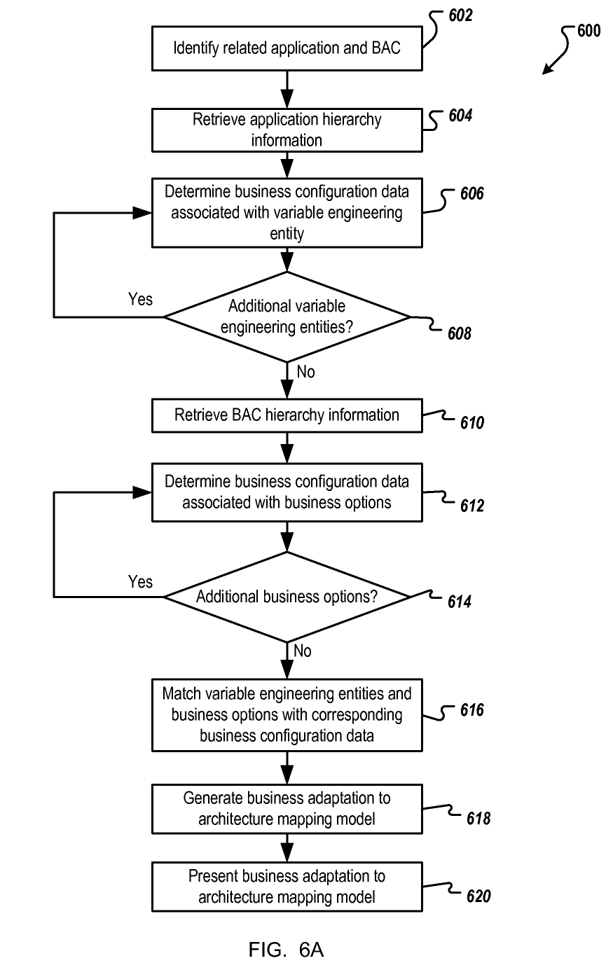

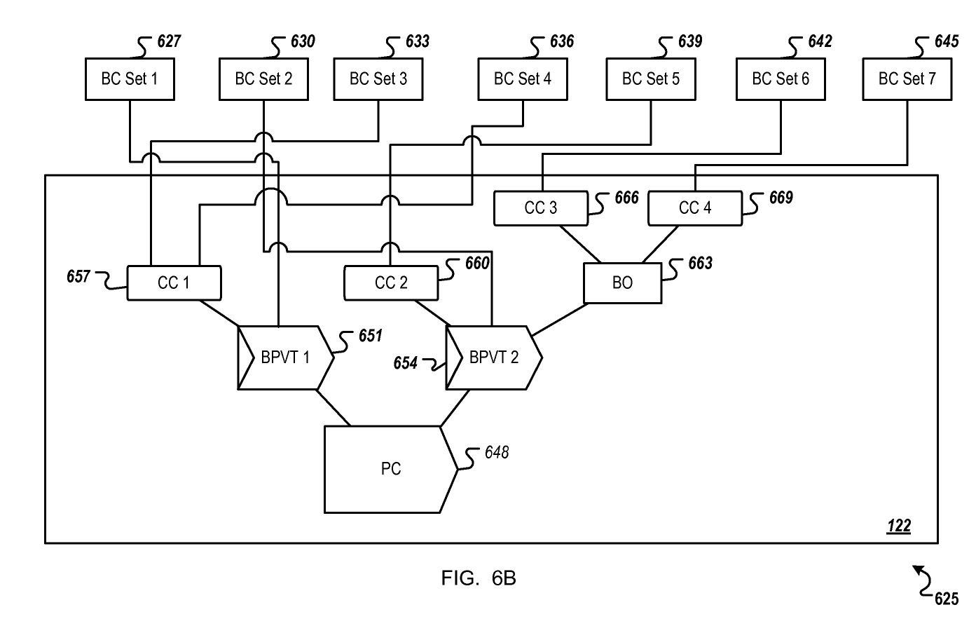

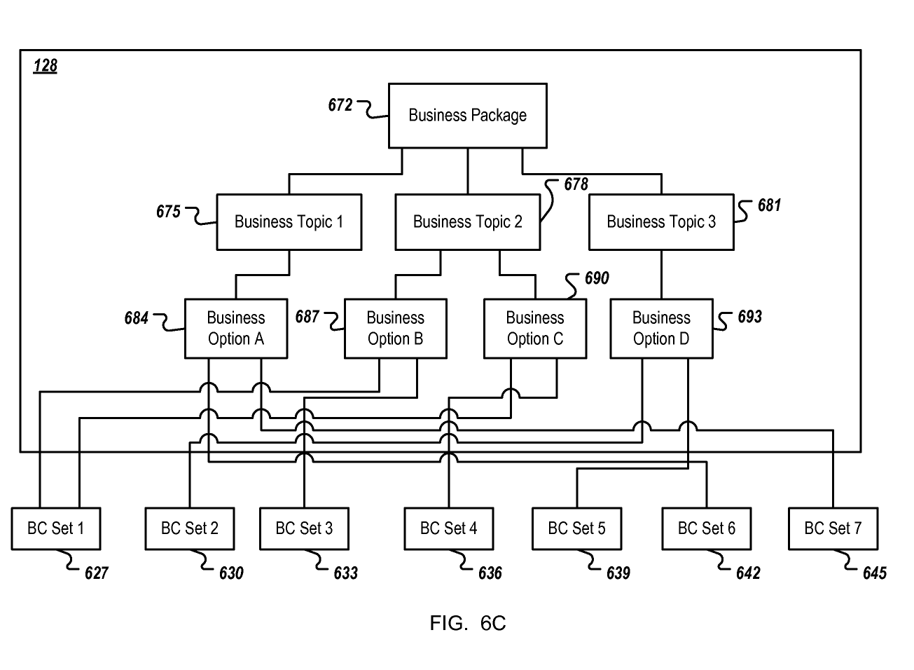

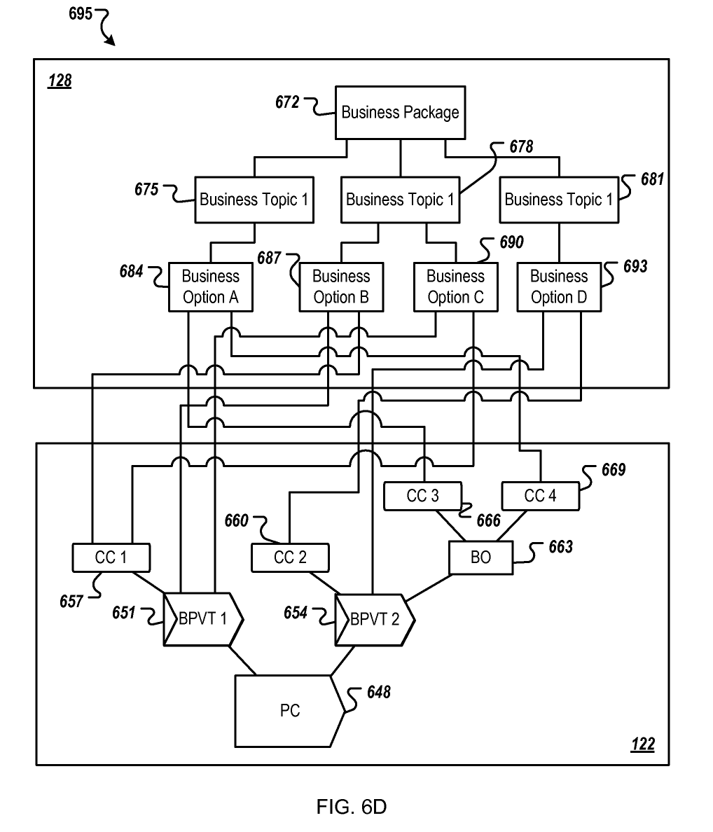

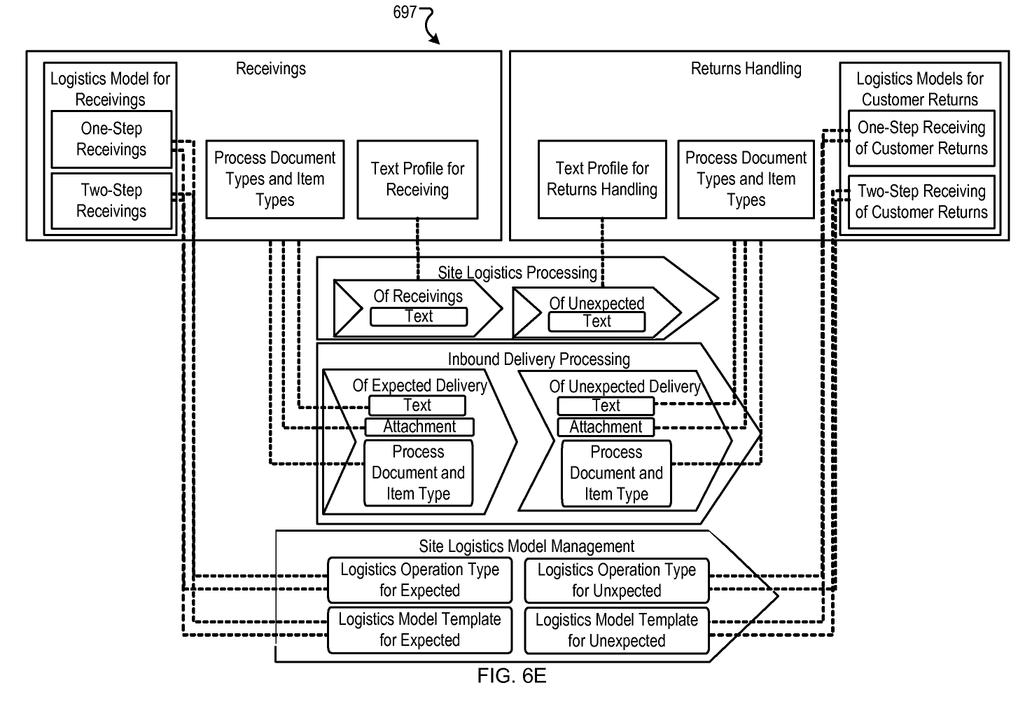

FIG. 6A illustrates an example method 600 for mapping one or more business elements of a particular BAC to a plurality of application entities. By mapping the relationship between business elements and application entities, a model representing the connections between certain business options (of the BAC) and configuration controls and BPVTs (of the application) can be generated. Using these mapped connections and the generated business adaptation to architecture mapping model, certain BAC constraints can be verified, and the BAC's (and its related solution's) integrity can be verified. In addition to verifying a particular BAC and its constraints, the mapped connections between the BAC and the application entities can be also be used to automatically generate one or more constraints in the BAC based on the constraints defined in the application.

At 602, method 600 identifies a related application and BAC. As previously described, environment 100 (illustrated in FIG. 1A) contains one or more solutions 126, each solution 126 associated with a BAC 128 defining the business elements (and a set of constraints associated therewith) available to the solution 126, as well as the underlying application 122 upon which the BAC 128 is based or associated. The BAC 128 represents customized sets of business elements defined to provide customer-specific and focused functionality on top of a defined application 122. In some instances, identifying the related application 122 and BAC 128 may comprise identifying a particular solution 126, and by doing so, its associated BAC 128 and underlying application 122. The solution 126 is associated with a particular application 122 (or instance, subset, or superset of the application platform 124, and thus, once a solution 126 is identified, both its associated BAC 128 and related application 122 are identified. In other instances, a developer may select a particular BAC 128 from a set of BACs 128 associated with a particular application 122 for which to perform method 600. Other suitable methods of identifying an application and its related BAC may also be used.

Once the pair has been identified, the hierarchy of entities associated with the application is retrieved at 604. In some instances, the retrieval of the application entity hierarchy may be retrieved from a file (e.g., a text file or a flat file) storing the application entities in a hierarchical tree structure, while in other instances, retrieval of the application hierarchy may be derived from one or more models associated with the application. In some instances, the hierarchy may be derived using certain modeling APIs 118 defined in the modeling environment 116 to access and return a hierarchical analysis (or representation) of the application's entities.

Once the application's hierarchical information is retrieved, the business configuration data associated with a particular one of the application's variable entities can be determined at 606. In the application, the variable engineering entities are BPVTs and configuration controls. All variability in the application is represented and described by these two types of engineering entities. Further, each instance of these variable engineering entities is associated with a particular set of business configuration data. Once it is determined which variable engineering entities of the application are associated with which particular sets of business configuration data, a visual representation of the application's hierarchy and its variable engineering entities' connections to certain business configuration sets can be created, such as the example visual representation illustrated in FIG. 6B. After the business configuration data is determined for a particular variable engineering entity, method 600 continues to 608 and determines whether additional variable entities remain in the application hierarchy. If additional variable engineering entities exist, method 600 returns to 606 and determines the business configuration data for the next variable engineering entity of the application. If there are no remaining variable entities, then method 600 continues at 610.

FIG. 6B illustrates a hierarchical representation of the entities associated with an application after 606 and 608 of method 600 have been completed. The portion of application 122 illustrated in FIG. 6B contains a process component 648 with two BPVTs: BPVT 1 (651) and BPVT 2 (654). BPVT 1 (651) includes a single configuration control 657 (CC 1). Additionally, BPVT 2 (654) contains configuration control CC 2 (660) and a business object 663. The business object 663 within BPVT 2 (654) includes two configuration controls: CC 3 (666) and CC 4 (669). Each of the variable entities illustrated in FIG. 6B are associated with a particular business configuration set. For example, CC 1 (657) is associated with BC Set 3 (633) and BC Set 4 (636). BPVT 1 (651) is associated is with BC Set 1 (627). BPVT 2 (654) is associated with BC Set 2 (630), and CC 2 (660) is associated with BC Set 5 (639). CC 3 (666) is associated with BC Set 5 (639), while CC 4 (669) is associated with BC Set 7 (645). The associations can be temporarily stored as a model 104 in memory 105 or within the modeling environment 116, as well as in any other appropriate data structure suitable for storing such information.

Returning to FIG. 6A, method 600 retrieves at least a portion of the hierarchical representation of the various business elements in the identified BAC at 610. As previously described, in some instances the hierarchical BAC information may be stored similar to BAC 315 of FIG. 3B, such as in a text or flat file, as well as in any other appropriate data structure. The information may be retrieved from such data structures to provide a hierarchical representation of the identified BAC. Additionally, the hierarchical BAC information may be retrieved from one or more models (such as those generated according to method 300 of FIG. 3A) using one or more modeling APIs 118 or other portions of the modeling environment 116. In other instances, the BAC hierarchical information may be retrieved in any suitable manner.

At 612, the business configuration data associated with a particular business option from the BAC is determined. In the BAC, only business options carry, or are associated with, specific business configuration data. Business configuration data to be used by the application at runtime is provided solely by business options. Method 600 performs the step of 612 until no additional business options remain. Once it is determined at 614 that all business options have been analyzed, method 600 continues at 616. In some instances, each business option may represent a 1:1 relationship with a particular set of business configuration data. In other instances, one business option may map to more than one set of business configuration data when the business option contains interrelated configuration entries from different tables and schemas (e.g., the Text and Attachment Settings business option). Additionally, in some instances multiple business options may be mapped to the same configuration entity when the same configuration entries are offered to the customer by the BAC in two places, or when the business options represent alternative choices for realizing the same configuration control (or other variable engineering entity). For instance, this may occur because the configuration entries are required in different contexts and the developer elected not to create a dedicated element for each specific context. In any event, the BAC hierarchy, as well as the business options and their associated business configuration sets may be visually represented similar to the application entities. An example of such a visual representation is illustrated in FIG. 6C.

FIG. 6C provides an illustration of a portion of the hierarchical relationship between a plurality of business elements within the identified BAC 128, specifically the portion corresponding to the application entities illustrated in FIG. 6B, as well as each business option's associations with one or more business configuration sets as defined by the BAC 128. The business elements illustrated include a business package 672 comprising three business topics: Business Topic 1 (675), Business Topic 2 (678), and Business Topic 3 (681). Business Topic 1 (675) includes one business option: Business Option A (684). Business Topic 2 (678) includes two business options: Business Option B (687) and Business Option C (690). Business Topic 3 (681) includes Business Option D (693). Each of the four business options are associated with one or more business configuration sets. For example, Business Option A (684) is associated with BC Set 6 (642) and BC Set 7 (645). Business Option B (687) is associated with both BC Set 1 (627) and BC Set 3 (633). Business Option C (690) is associated with BC Set 1 (627) and BC Set 4 (636). Further, Business Option D (693) is associated with BC Set 2 (630) and BC Set 5 (639). Similar to the hierarchical representation of the application entities, the visual representation of FIG. 6C can be temporarily stored with the models 104 in memory 105 or within the modeling environment 116, as well as in any other appropriate data structure suitable for storing such information.

FIG. 6E provides one concrete example of a mapping between business entities Receivings and Returns Handling (and their associated business options) of a particular BAC to the engineering entities of the particular BAC's underlying application, the engineering entities including the Site Logistics Processing, Inbound Delivery Processing, and Site Logistics Model Management process components. FIG. 6E is an example of a model illustrating the BAC-application constraints at an architectural level (i.e., between a BAC 's Receivings business topic and Returns Handling business topic and the application's various process components, BPVTs, and configuration controls).

Once the business configuration data associated with the variable entities of the application and the business options of the BAC are determined (and as described herein, visualized), method 600 maps the variable entities and business options at the configuration level (based on matching business configuration sets) at 616. These relationships can be identified by analyzing which business configuration sets are shared by certain business options and variable entities. For instance, because BPVT 1 (651) is associated with BC Set 1 (627) (as illustrated in FIG. 6B), and because Business Option B (687) and Business Option C (690) are also both associated with BC Set 1 (627), BPVT 1 (651) can be mapped to the both Business Option B (687) and Business Option C (690) of the BAC. These mappings can be determined for each variable engineering entity in FIG. 6B and each business option of FIG. 6C, and can be combined at 618 of method 600 to generate the business adaptation to architecture mapping model 695 illustrated in FIG. 6D. The business adaptation to architecture mapping model 695 represents the logical connections between the configuration entities (the variable entities of the application and the business options of the BAC). In addition to providing a connection between the configuration entities, the business adaptation to architecture mapping model 695 can provide information describing which business options and elements must be enabled or activated in order to satisfy the integrity requirements of the application 122. As will be further described herein, the business adaptation to architecture mapping model 695 (as well as the underlying connections between business options and variable entities) can be used to automatically generate constraints in the BAC based on the constraints previously defined in the application 122 among the various application entities.

At 620, the business adaptation to architecture mapping model can be presented. In one instance, the business adaptation to architecture mapping model (e.g., model 395) can be presented to a customer or developer via GUI 142. Where the model 395 is too detailed to be presented in its entirety, a selected or relevant portion of the model may be presented in a particular view 144 to client 110. Further, presenting the business adaptation to architecture mapping model may include storing the business adaptation to architecture mapping model in memory 105 along with the other models 104 as illustrated in FIG. 1A. In still other instances, presenting the business adaptation to architecture mapping model at 620 may comprise exporting the information defining the business adaptation to architecture mapping model into a documentation system. For instance, the information and models representing the business adaptation to architecture mapping model may be used to automatically create documents explaining or describing the relationships between variable application entities and business options as illustrated in the generated business adaptation to architecture mapping model. The business adaptation to architecture mapping model may also be used to define the organization of documents within the documentation system based upon the business element hierarchy and constraints. Further, the business adaptation to architecture mapping model may be used to create or generate figures for the documentation system, such as flowcharts, illustrations, and examples of the various relationships within the business adaptation to architecture mapping model.

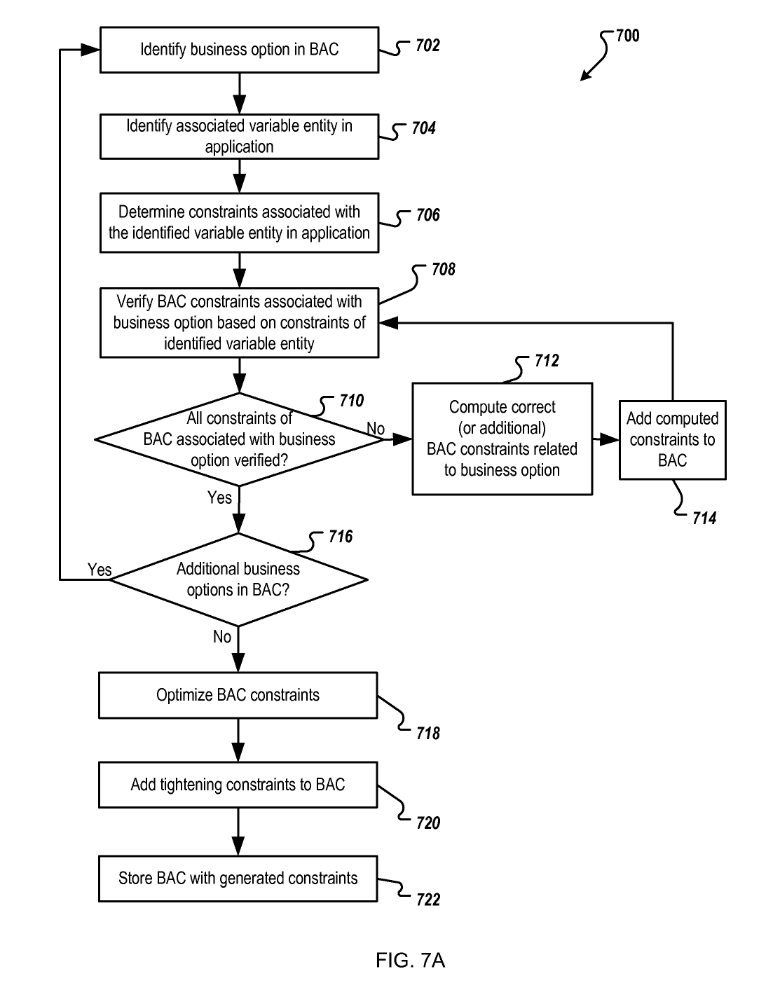

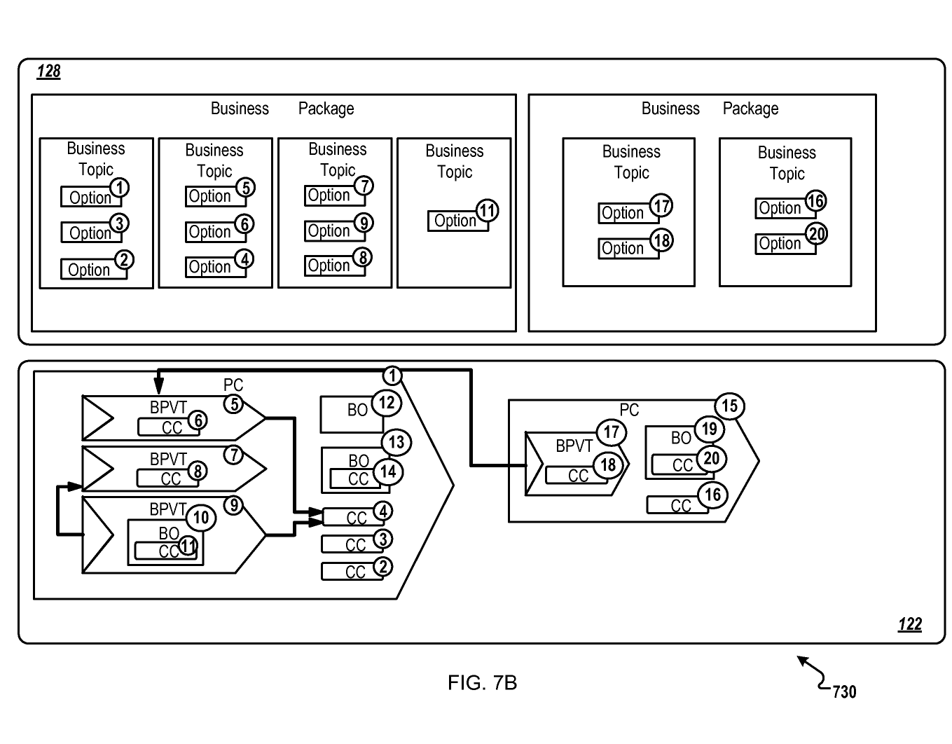

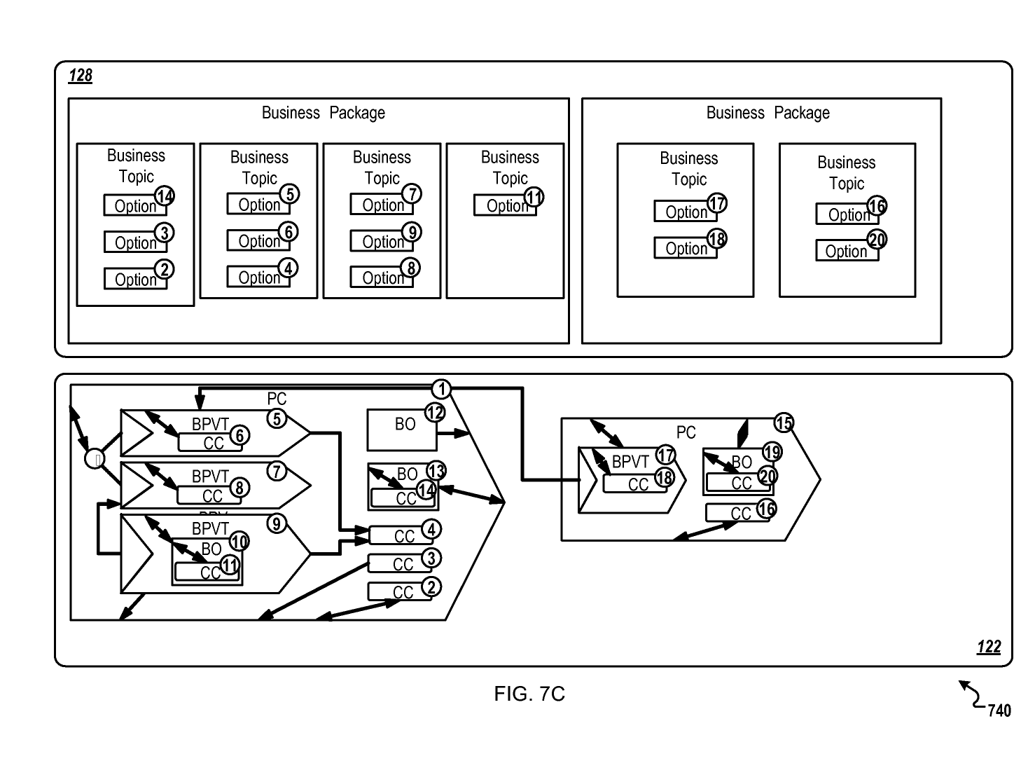

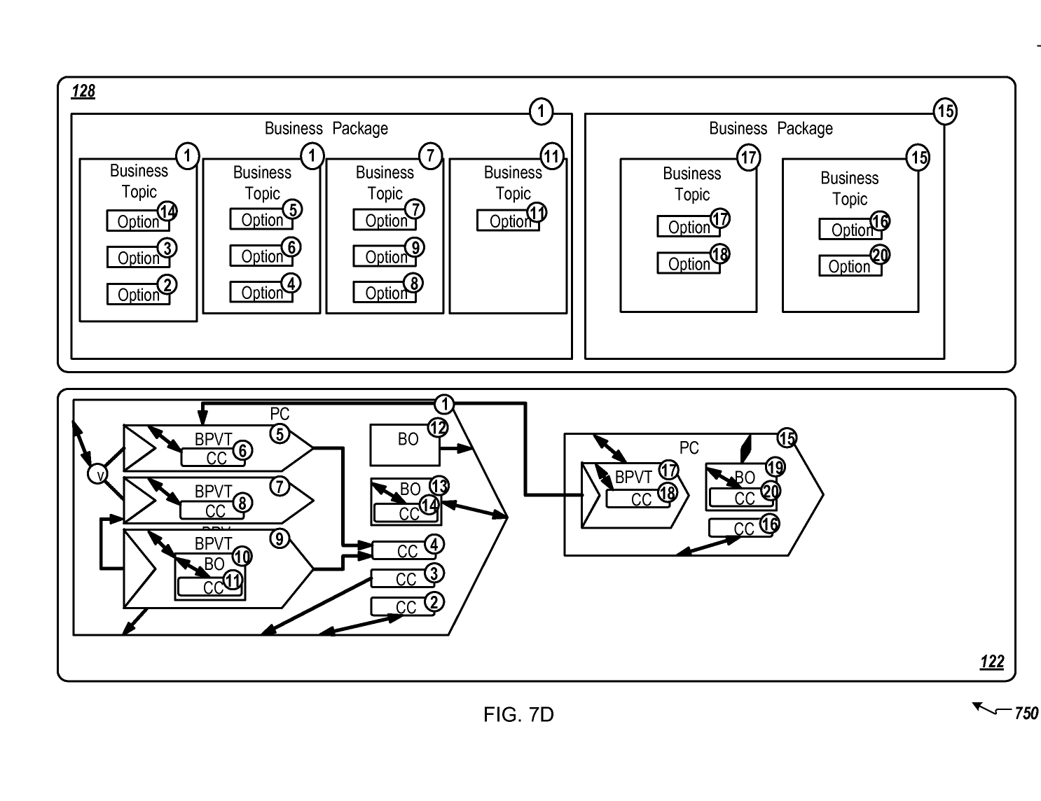

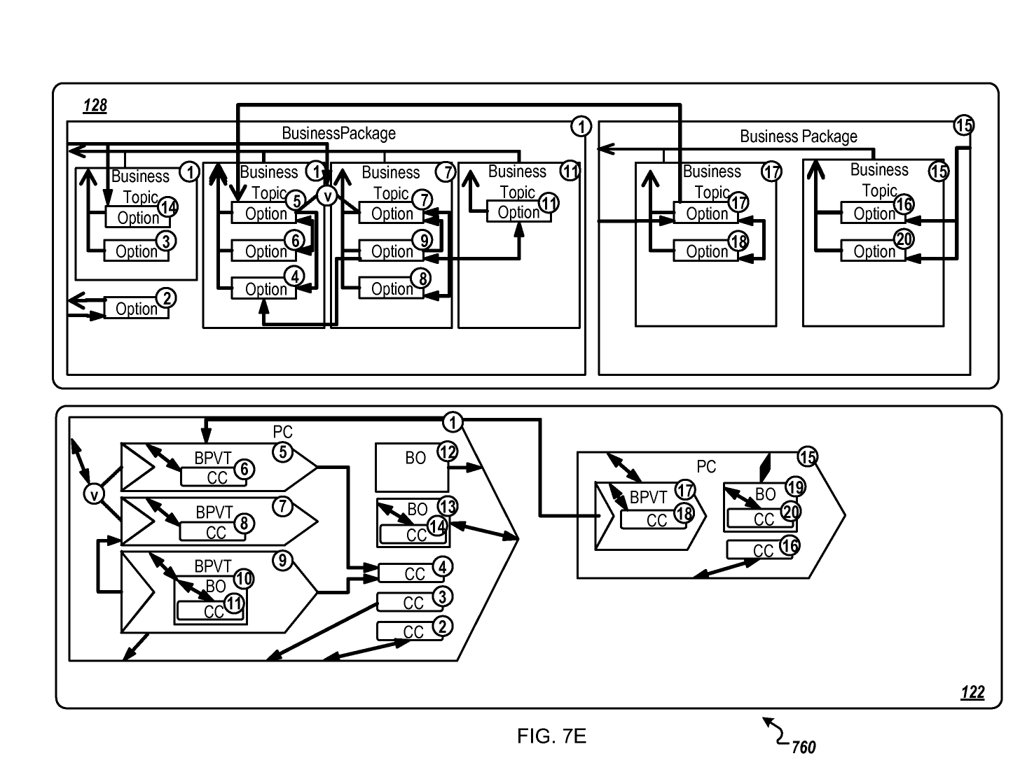

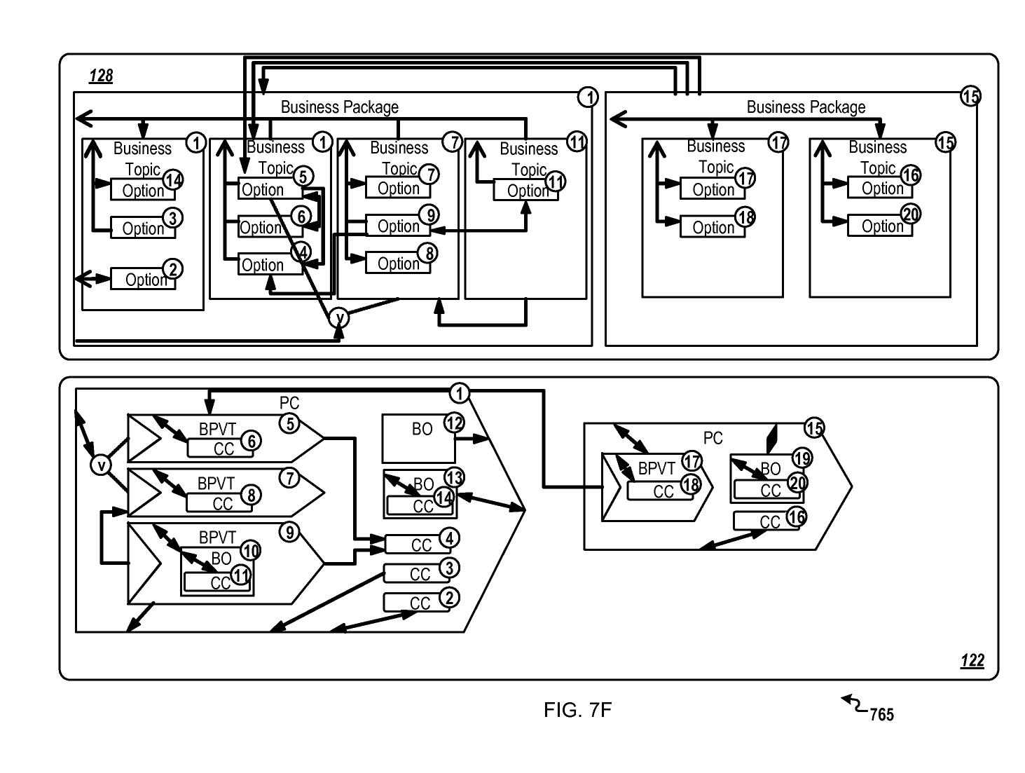

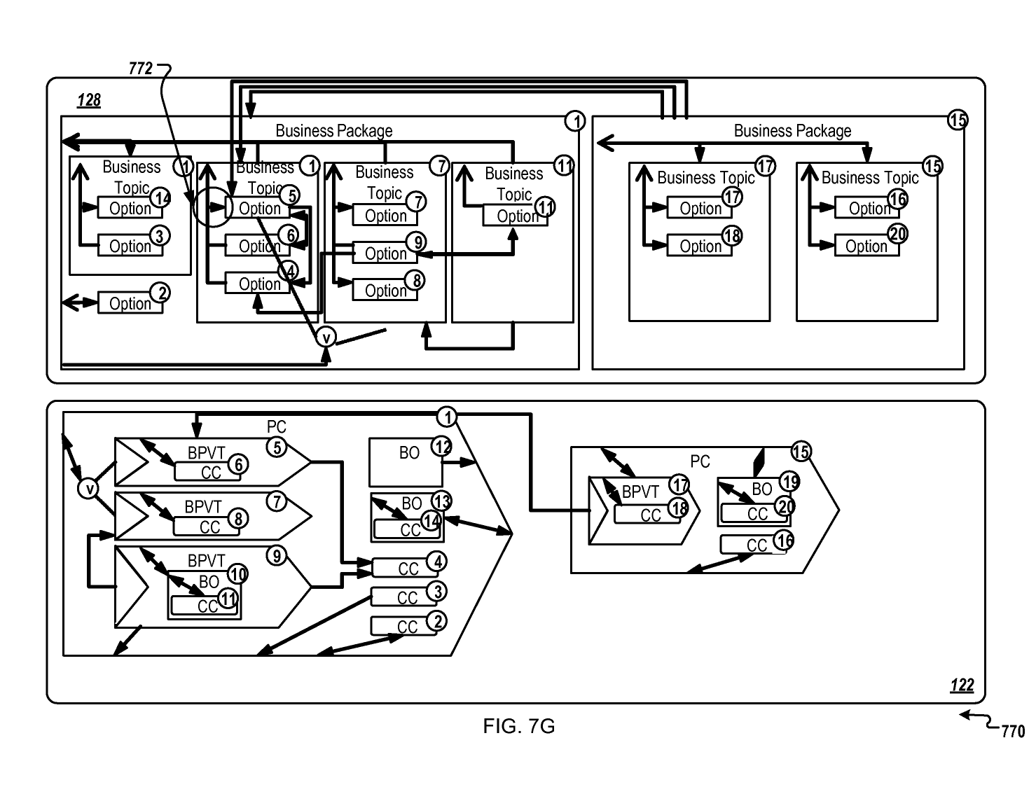

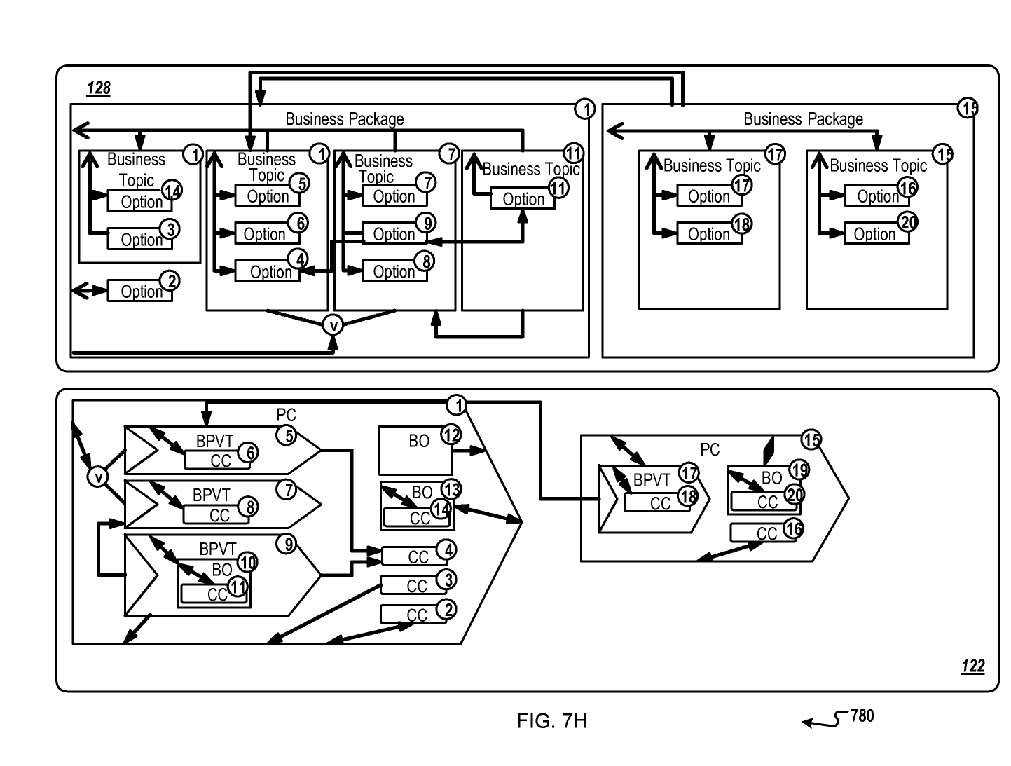

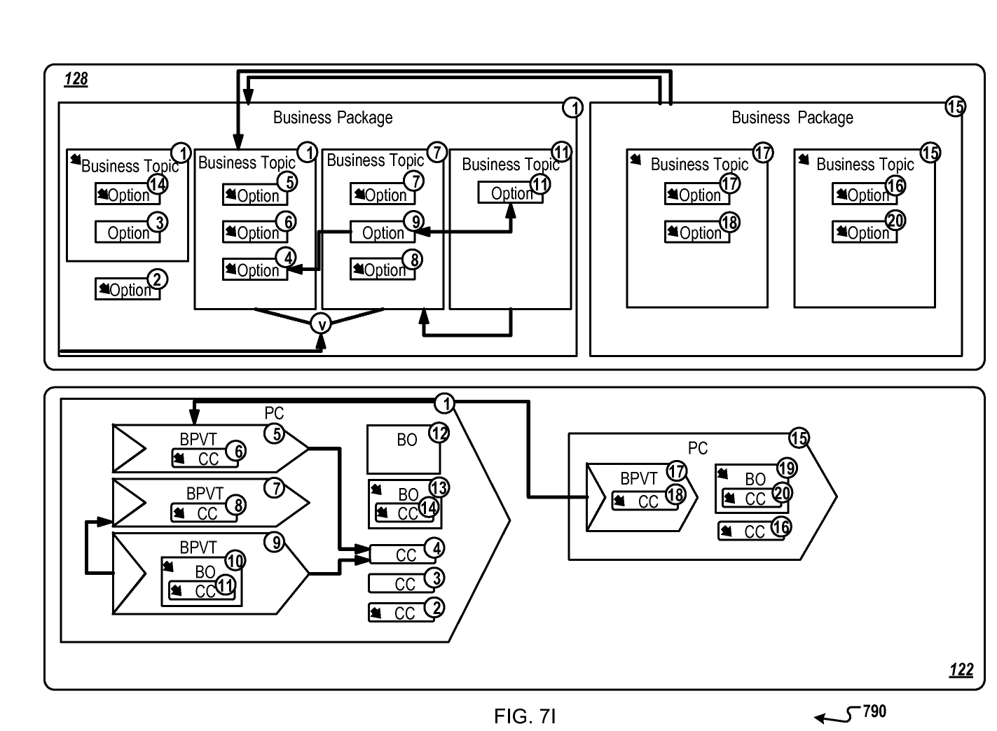

FIG. 7A illustrates an example method 700 for verifying, and in some cases, generating, one or more constraints within a BAC based on one or more constraints defined in the underlying or associated application. Method 700 can take advantage of a combination of a process component constraint model generated by method 500 (of FIG. 5A) and the mapping information derived by method 600 (of FIG. 6A), in that the relationships between certain business options in the BAC and certain variable engineering entities in the application can be used to verify that the constraints defined for application engineering entities are supported and reflected by the constraints defined in the BAC. In instances where the application constraints are not ensured by the BAC, an automatic process for generating the correct constraints can be implemented. Additionally, if no BAC constraints have been created by customers or developers, method 700 can be used to generate the BAC constraints based upon the constraints defined for the associated application entities.

At 702, method 700 identifies a particular business option in the BAC. In some instances, the business option identified at 702 may be based on the hierarchical (or tree) representation of the BAC (as illustrated in FIG. 3B). The first business option selected may be the first business option read in the hierarchy. At 704, a variable engineering entity from the application associated with the business option is identified. Where a business adaptation to architecture model (or the information associated therewith) has been generated (such as by example method 600 of FIG. 6A), information on the connection from the identified business option to the associated variable engineering entity in the application can be retrieved. In some instances, one or more modeling APIs 118 can be used to access the appropriate business adaptation to architecture model to retrieve information defining the associated variable engineering entities. If the business option has not been mapped to one or more variable engineering entities, method 600 (or another method of mapping business options to variable engineering entities) can be run so that the appropriate mappings can be determined. As previously discussed, the business option and variable engineering entity are associated because the business configuration data of the business option conforms to the schema of the variable engineering entity.

At 706, the constraints associated with the identified variable engineering entity in the application are determined. For example, the constraints defined for a particular variable engineering entity may be retrieved from a process component constraint model (such as a model generated by method 500 of FIG. 5A). Constraint information may be retrieved using one or more modeling APIs 118 to determine the constraints defined for the identified variable engineering entity in the entity's associated process component constraint model. Additionally, the constraint information for a particular entity may be located in a data structure associated with the process component constraint model. The modeling APIs, or any other appropriate module within environment 100, may retrieve the necessary information.

After the constraint information associated with the identified variable engineering entity is determined, at 708 the application entity constraint information is used to verify the BAC constraints defined for (or associated with) the identified business option (identified at 702). For example, the variable engineering entity associated with the identified business option may have constraints related to other variable engineering entities, such as a configuration control within a BPVT. If the constraints associated with the configuration control indicate that the configuration control is activated by the BPVT, then the business option within the BAC associated with the configuration control will be activated by the business option associated with the BPVT. This will ensure that the BAC configuration satisfies the integrity constraints of the application. The verification process of 708 comprises determining whether the constraints of the variable engineering entities in the application correspond to the constraints defined in the BAC. In some instances, the BAC may include incorrect constraints based on the application's constraints, while in other instances, the BAC may be missing one or more constraints associated with the variable engineering entity. Both situations can be handled adequately by method 700.

At 710, method 700 determines whether the constraints in the BAC associated with the business option (identified at 702) are verified as correctly corresponding to the constraints defined for the business option's associated variable engineering entity. If 710 determines that the BAC constraints of the business option are correct, then method 700 continues at 716. At 716, method 700 determines whether additional business options remain for verification in the BAC. If additional business options have not been run through the verification process, then method 700 returns to 702 and identifies the next business option to be verified. If all other business options have been verified, then method 700 continues at 718.

Returning to 710, if it determined that one or more errors were found in the BAC constraints associated with the identified business option, then method 700 continues at 712. At 712, a set of additional or corrected BAC constraints related to the identified business option are computed. The process of computing the correct constraints may comprise computing the constraints associated with the application's variable engineering entity, including the business options (and other business elements, such as business topics and/or business packages) associated with the application entities which the identified variable engineering entity is associated. Returning to the constraint between the configuration control and BPVT described above with relation to 708, the identified variable engineering entity for the identified business option can be the configuration control. In the application, the configuration control depends on (or is activated by) the related BPVT based on constraints in the process component constraint model. Further, the BPVT may be known to be associated with a particular business option in the BAC based on the mapping between the BAC and application. The error determined at 708 may be that the identified business option (associated with the configuration control) is not constrained to be dependent upon the business option associated with the BPVT. Therefore, in the BAC, the configuration control business option may be activated while the BPVT business option is not. Clearly, this situation would violate the defined integrity of the application, and cause an error based on the missing constraint between the configuration control business option and the BPVT business option. This required addition to the BAC constraints is computed at 712. In some instances, the constraints of the BAC may be incorrect as opposed to missing. In those situations, 712 may determine which BAC constraints to remove, and calculate the correct constraints to be added to the BAC.

Once the correct constraints for the BAC are determined, method 700 adds the newly calculated constraints to the BAC at 714. These new constraints can be added to a BAC model representing the BAC, as well as directly to the constraint table of the BAC (e.g., constraint table 319 of FIG. 3B). In some instances, the modeling APIs 118 may be used to add the new constraints to the BAC (and/or its model). Any suitable component within environment 100 (in addition to non-illustrated components) may also be used to add the new constraints into the BAC. Once the new constraints are added to the BAC, method 700 may return to 708 to re-attempt verification of the BAC constraints after the addition at 714. If 714 operates properly, the BAC constraints associated with the identified business option will be verified, and method 700 can continue at 716 to determine whether additional business options are available to be verified.

After all business options in the BAC have been verified and/or corrected by method 700, such that the BAC includes the constraints required to correspond to the application, one or more of the BAC constraints may be optimized at 718. Optimization of BAC constraints may include delegating constraints to higher level elements within the BAC (where possible), as well as combining related constraints (i.e., combining an “activates” constraint and a “depends on” constraint to form a “subordinate” constraint, thus optimizing two constraints into one). For example, if a first business option “activates” all business options within a particular business topic, then instead of multiple constraints from the first business option to each of the business options, the first business option's constraint may be modified to an “activates” constraint for the particular business topic, and not each of the business options individually. Many other methods of optimizing constraints may be used in connection with method 700 or another similar method thereto. In general, optimizing the BAC constraints can provide a clearer, more concise representation of the BAC constraints to customers and developers during the design of a solution 126. By removing unnecessary or redundant constraints, a more understandable BAC can be provided, allowing for better-defined solutions 126 to be created in an easier manner. In some instances, the optimization step of 718 may be performed automatically by the modeling environment 116 based on one or more defined optimization rules.

Once the BAC has been modified to include all constraints necessary for the application, additional tightening constraints may optionally be added to the BAC at 720. Additional constraints may be used to provide a more specific solution 126 than required by the application itself. These additional constraints can be manually added by a customer or developer using the modeling tool 140 to modify the BAC model, or by adding constraints directly to the data structure representing the BAC. However, while additional constraints can be added to the BAC, constraints generated or verified by method 700 cannot be deleted from the BAC, as deleting a required constraint may cause the application to fail when executed using the modified BAC. In other words, the verified and/or generated constraints represent the minimal constraints necessary to ensure the integrity of the BAC in light of the application's integrity constraints. When tightening constraints are added to the BAC at 720, method 700 may return to 718 to optimize one or more of the newly added constraints.

After completing the optional steps of 718 and 720, the newly generated and/or modified BAC can be stored. For example, the data structure and constraints of the modified BAC can be stored in memory 105, as well as with the plurality of solutions 126. Additionally, a BAC model visually representing the newly defined and updated BAC may be stored with models 104 of memory 105.

FIGS. 7B-F provide example illustrations of the effect of method 700. It should be noted, however, that in some instances, method 700 is performed internally and is not modeled as shown in FIG. 7B-F. In other words, the constraint generation method may be performed automatically without the need for a visual representation as illustrated herein. However, even for instances where no visual representation of method 700 is provided, FIGS. 7B-F can be used to better understand one example of how method 700 is performed. Reference to the figures will be made generally to provide an overview of the actions associated with method 700.

The example of FIGS. 7B-7F illustrate an instance for method 700 where the BAC has no predefined constraints, or where all constraints previously associated with the BAC have been removed. In instances where the BAC is constraint-free, method 700—after identifying a business option in the BAC (at 702), identifying a variable engineering entity associated with the identified business option in the application (at 704), and determining the constraints associated with the identified variable engineering entity (at 706)—can move directly to 712 to compute the BAC constraints related to the identified business option as determined by the constraints related to the identified variable engineering entity.

FIG. 7B illustrates one example of a business adaptation to architecture model 730 representing the connections from a plurality of business options within the BAC 128 to a plurality of variable engineering entities in the application 122. Instead of lines drawn from business option to variable engineering entity, numbers representing the correct mapping are used. For instance, the business option numbed 14 in the BAC portion of the model 730 corresponds to the configuration control numbered 14 in the application portion of the model 730. In this manner, a clean view of the relationships is provided. In addition to the associations between business options and variable engineering entities, the application 122 portion of the model illustrates several constraints generated by the application developer to provide the required integrity of the application 122. As one example of the constraints, BPVT 17 is illustrated as activating BPVT 5, while BPVT 17 also required configuration control 18.

The business adaptation to architecture model 730 of FIG. 7B illustrates the explicit constraints associated with each of the variable engineering entities in the application 122. In some examples, at 706 of method 700, the explicit constraint information associated with the model 730 may be retrieved and used to determine the constraints for a particular variable engineering entity. Additionally, the implicit constraints associated with the business adaptation to architecture model 730 can be illustrated by the modified business adaptation to architecture model 740 of FIG. 7C. For example, it is implicitly understood that at least one of illustrated BPVT 5 and BPVT 7 of FIG. 7C needed, and that relationship is identified by the “OR” operator added to the model 740. In this instance, one of the two BPVTs will be activated when process component 1 is activated. Similarly, because process component 15 includes only one BPVT 17, then that one BPVT 17 must be activated whenever process component 15 is activated. Additionally, process component 15 must be activated when BPVT 17 is activated in order for the BPVT 17 to be available. Generally, these implicit constraints would not be modeled in normal business adaptation to architecture models, but are shown here to better understand the constraint generation steps of method 700.

FIG. 7D illustrates the business adaptation to architecture model 750 wherein the basic constraints due to the BAC's hierarchical nature are added. For instance, each business option within a business topic in FIG. 7D is now illustrated as “depending on” its business topic. Similarly, each business topic within a business package is illustrated as “depending on” its business package. In other words, business adaptation to architecture model 750 makes the implicit constraints within the BAC 128 explicit prior to determining the additional constraints dictated by the associated variable entities. Additionally, the business adaptation to architecture model 750 of FIG. 7D derives mappings between the higher level elements of the BAC 128 and the higher level elements of the application 122. One example of this determination that the business package in the top-left portion of FIG. 7D can be mapped to the process component labeled 1, as all business options within the top-left business package comes from that process component. Based on that understanding, which can be derived from the business adaptation to architecture model 750, the top-left business package is mapped to process component 1, and is labeled in FIG. 7D with a “1” to indicate that mapping. Similar determinations can be made for both the other business package and the business topics also located within the BAC 128.

Once these additional mappings are added to the business adaptation to architecture model 750, the process of determining the constraints associated with each business option is provided. The business adaptation to architecture model 760 of FIG. 7E illustrates the addition of the option level constraints to the BAC 128 as determined from the constraints of the variable entities in the application 122. For instance, configuration control 6 is associated with a “activates” constraint linked to BPVT 5, and vice versa, in the application 122. Thus, a double-sided “activates” constraint is added between business options 5 and 6 in the BAC 128 to represent that constraint. Other option level (or variable engineering entity level) constraints have also been added to the BAC 128 in FIG. 7E.

FIG. 7F illustrates the business adaptation to architecture model 765 after several layers of optimization have been performed on the BAC's constraints, such as at 718 of method 700. For example, where possible, constraints have been moved from the lower level elements (such as business options) to higher level elements in order to element one or more constraint arrows from the model. For instance, the configuration control 18 modeled in application 122 needs BPVT 17, and therefore process component 15, and therefore business object 19, and therefore configuration control 20, as well as configuration control 16. Instead of adding all of these constraints to the BAC 128 constraints, it can be understood that each of the elements in process component 15 needs each of the other elements. As process component 15 has previously been mapped to business package 15 and business topic 15 in the BAC 128, the constraints for the business elements within business package 15 can be moved up to the higher level as shown in business package 15 of FIG. 7F. In other words, when business package 15 is activated, business topic 17 and business topic 15 are both activated, as well as each topics business options. A comparison of business package 15 in FIGS. 7E and 7F shows that the optimization process provides a clearer, and less cluttered, illustration of the constraints for business package 15. Similar optimizations can be made throughout the BAC 128. Once the optimizations are performed, business adaptation to architecture model 765 illustrates the current set of BAC constraints generated by method 700 for the application 122.

FIG. 7G illustrates the business adaptation to architecture model 770 after a customer or developer has added a tightening constraint to the BAC (720 of method 700). As pointed out by element 772, the tightening constraint in FIG. 7G represents the addition of an “activates” constraint from business topic 1 to business option 5. Based on the tightening constraint, the optimization process (718 of method 700) is rerun in order to determine whether additional constraints can be removed from the BAC. It should be noted that in FIG. 7G, business options 6 and 7 are activated by business option 5. Since the tightening constraint added indicates that business option 5 is “activated” by business topic 1 (which corresponds with business package 1 as well), several optimizations can be made as illustrated in FIG. 7H. One example of the optimizations made is that each business option within business topic 1 (business option 4, 5, and 6) is now associated with an “activated” constraint from business topic 1. Other optimizations were also made to the business adaptation to architecture model 780 based on the additional constraint.

FIG. 7I illustrates the final result of the BAC constraint generation process performed by method 700 in the illustrated example. First, the implicit constraints in both the BAC 128 and the application 122 have been removed. Additionally, the shorthand constraint for “activates” have been added back into the business adaptation to architecture model 790 in order to remove unnecessary arrows from cluttering the model. Further, only the explicit constraints are illustrated in both the BAC 128 and the application 122 portions of the model 790.

As illustrated, method 700 provides for a clear and concise description of BAC constraints generated from the constraints associated with the variable entities of the application 122. By automating the generation of BAC constraints from the constraints defined in the application and between the variable application entities, BAC configuration constraints can be created that ensure the integrity of the application after customers and developers perform scoping for solutions based on the automatically-generated BAC. This significantly improves development efficiency because customers and developers creating the solutions 126 are required to create fewer solution constraints than before, thereby saving time and development effort to create new or amended solutions 126. Further, the optimization process of the BAC constraints provides additional transparency to the BAC and the BAC model by reducing, combining, and optimizing the constraints contained in the BAC. Finally, the business adaptation to architecture models modified and created by the automatic generation process can be used by developers to quickly test solutions and constraints.

The subject matter has been described in terms of particular variations, but other variations can be implemented and are within the scope of the following claims. For example, the actions described herein can be performed in a different order than as described and still achieve desirable results. As one example, the methods and processes depicted in the accompanying figures do not necessarily require the particular order shown, or sequential order, to achieve the desired results. In certain implementations, multitasking and parallel processing may be advantageous. Other variations are within the scope of the following claims.

What is claimed is:

1. Software for automatically generating one or more business adaptation catalog constraints, the software comprising computer-readable instructions embodied on tangible media and operable when executed to:
identify at least one business option associated with a business adaptation catalog;
identify at least one variable application entity in an application mapped to the at least one identified business option;
determine one or more application integrity constraints associated with the at least one identified variable application entity;
compute one or more business adaptation catalog constraints associated with the at least one identified business option based on the one or more determined application integrity constraints associated with the at least one identified variable application entity; and
insert the one or more computed business adaptation catalog constraints associated with the at least one identified business option into the business adaptation catalog.

2. The software of claim 1 further operable when executed to generate a business adaptation model representing the one or more inserted computed business adaptation catalog constraints.

3. The software of claim 1 further operable to present a business application catalog model including the one or more inserted computer business adaptation catalog constraints to a user via an interface.

4. The software of claim 1 further operable to store the business application catalog including the one or more inserted computer business adaptation catalog constraints in a tangible memory.

5. The software of claim 1, wherein inserting the one or more computed business adaptation catalog constraints associated with the at least one identified business option comprises replacing at least one business adaptation catalog constraint defined for the business adaptation catalog prior to computing the one or more business adaptation catalog constraints.

6. The software of claim 1, wherein identifying the at least one variable application entity in the application mapped to the at least one identified business option comprises deriving the mapping from a business adaptation to architecture model.

7. The software of claim 1, wherein determining the one or more application integrity constraints associated with the at least one identified variable application entity comprises deriving the application integrity constraints from a process component constraint model.

8. The software of claim 1 further operable to verify one or more business adaptation constraints associated with the at least one business option prior to computing the one or more business adaptation catalog constraints by comparing the prior-existing business adaptation constraints associated with the at least one business option to the computed business adaptation catalog constraints related to the at least one business option.

9. The software of claim 1 further operable to replace the one or more prior-existing business adaptation catalog constraints with the computed business adaptation catalog constraints when the prior-existing business adaptation catalog constraints are not equivalent to the computed business adaptation catalog constraints.

10. The software of claim 1 further operable to automatically optimize the one or more computed business adaptation catalog constraints added to the business adaptation catalog.

11. The software of claim 1 further operable to:
receive one or more additional restrictive constraints for the business adaptation catalog from a user after the one or more computed business adaptation catalog constraints have been added to the business adaptation catalog; and
add the one or more received additional restrictive constraints to the business adaptation catalog.

12. The software of claim 11 further operable to automatically optimize the business adaptation catalog constraints after the one or more received additional restrictive constraints are added to the business adaptation catalog.

13. The software of claim 1, wherein the at least one variable application entity comprises either a business process variant type or a configuration control.

14. The software of claim 1, wherein the business adaptation catalog contains no constraints prior to computing the one or more business adaptation catalog constraints associated with the at least one identified business option.

15. The software of claim 1, wherein identifying the at least one variable application entity in the application mapped to the at least one identified business option comprises:
retrieving a first set of hierarchical information associated with the application;
retrieving a second set of hierarchical information associated with the business adaptation catalog;
determining a first set of business configuration data associated with at least one variable application entity included within the first set of hierarchical information;
determining a second set of business configuration data associated with at least one business option included within the second set of hierarchical information; and
mapping a connection between the at least one variable application entity and the at least one business option where the first set of business configuration data associated with the at least one variable application entity corresponds to the second set of business configuration data associated with the at least one business option.
